(19) United States
(12) Patent Application Publication
(10) Pub. No.: US 2021/0246069 A1
(43) Pub. Date: Aug. 12, 2021

(54) HEAT-TREATABLE ANTIMICROBIAL GLASS

(71) Applicant: Guardian Glass, LLC, Auburn Hills, MI (US)

(72) Inventor: Liang Liang, Auburn Hills, MI (US)

(73) Assignee: Guardian Glass, LLC, Auburn Hills, MI (US)

(21) Appl. No.: 16/973,151

(22) PCT Filed: Jun. 6, 2019
(86) PCT No.: PCT/IB2019/054734

§ 371 Date: Dec. 8, 2020

Related U.S. Application Data
(60) Provisional application No. 62/682,451, filed on Jun. 8, 2018.

(51) Int. Cl. C03C 17/00; C09D 5/14; C09D 133/06; C09D 4/06

(52) U.S. Cl. CPC C03C 17/009; C09D 5/14; C09D 133/062; C09D 4/06; C03C 2218/32; C03C 2217/445; C03C 2217/477; C03C 2217/478; C03C 2217/77; C03C 17/007

(57) ABSTRACT

A coated glass substrate is disclosed. The coated glass substrate includes a coating containing at least one metal oxide containing a zinc oxide. The zinc of the zinc oxide is present in an amount of from 5 wt. % to 50 wt. % as determined according to XPS. The coated glass substrate has area surface roughness Sa or Sq of from about 5 nm to about 1,500 nm as determined via atomic force microscopy.

### CROSS REFERENCE TO RELATED APPLICATION

The present application claims filing benefit of U.S. Provisional Patent Application Ser. No. 62/682,451 having a filing date of Jun. 8, 2018, and which is incorporated herein by reference in its entirety.

### BACKGROUND

Glass articles have many applications, including use in buildings and furniture. In general, such glass is formed by applying a coating formulation containing a binder and glass frit to the surface of a glass substrate and then thermally treating the substrate to remove the carrier or solvent. Previously, additional treatments, such as acid etching, mechanical polishing, sandblasting, and polymer film covering, have been used in order to form a translucent coating. However, such conventional methods for forming translucent coatings often suffer from shortcomings such as the inability to adjust the roughness of the coating, the inability to further temper the glass, and the need to avoid controlled etching of products.

As additional applications and functionalities of a substrate are identified, the properties of the glass articles need to be tailored for such applications. As such, a need continues to exist for improved glass articles containing coatings with improved antimicrobial properties, mechanical properties, adhesive properties, and/or self-cleaning properties. It would also be beneficial to form an improved glass article containing a coating with one or more improved properties and/or that may be tempered before or after applying a coating.

### SUMMARY

In general, one embodiment of the present disclosure is directed to a coated glass substrate comprising a coating containing at least one metal oxide containing a zinc oxide. The zinc of the zinc oxide is present in an amount of from 5 wt. % to 50 wt. % as determined according to XPS. The coated glass substrate has area surface roughness Sₐ or S_{q} of from about 5 nm to about 1,500 nm as determined via atomic force microscopy.

### BRIEF DESCRIPTION OF THE DRAWINGS

The invention will now be described, by way of example, with reference to the accompanying drawings, in which:

FIG. 1 is a view of a Scanning Electron Microscope (SEM) picture of a coating according to the present disclosure;

FIG. 2 is a graph showing an example of a particle size distribution of glass frit according to the present disclosure;

FIG. 3 is a graph showing the self-cleaning performance of an example prepared according to the present disclosure;

FIG. 4 shows two charts displaying antimicrobial performance of examples according to the present disclosure;

FIG. 5 is a flow diagram showing the method of forming a coated substrate according to the present disclosure; and

FIG. 6 is an X-Ray photoelectron spectroscopy spectrum of an example of a coating according to the present disclosure.

### DETAILED DESCRIPTION

### Definitions

It is to be understood that the terminology used herein is for the purpose of describing particular embodiments only and is not intended to limit the scope of the present invention.

“Alkyl” refers to a monovalent saturated aliphatic hydrocarbyl group, such as those having from 1 to 25 carbon atoms and, in some embodiments, from 1 to 12 carbon atoms. “Cx-yalkyl” refers to alkyl groups having from x to y carbon atoms. This term includes, by way of example, linear and branched hydrocarbyl groups such as methyl (CH3), ethyl (CH3CH2), n-propyl (CH3CH2CH2), isopropyl ((CH3)2CH), n-butyl (CH3CH2CH2CH2), isobutyl ((CH3)2CHCH2), sec-butyl ((CH3)(CH3CH2)CH), t-butyl ((CH3)3C), n-pentyl (CH3CH2CH2CH2CH2), neopentyl ((CH3)3CCH2), hexyl (CH3(CH2CH2CH2)5), etc.

“Alkenyl” refers to a linear or branched hydrocarbyl group, such as those having from 2 to 10 carbon atoms, and in some embodiments from 2 to 6 carbon atoms or 2 to 4 carbon atoms, and having at least 1 site of vinyl unsaturation (>C═C<). For example, (Cx-Cy)alkenyl refers to alkenyl groups having from x to y carbon atoms and is meant to include for example, ethenyl, propenyl, 1,3-butadienyl, and so forth.

“Aryl” refers to an aromatic group, which may have from 3 to 14 carbon atoms and no ring heteroatoms and having a single ring (e.g., phenyl) or multiple condensed (fused) rings (e.g., naphthyl or anthryl). For multiple ring systems, including fused, bridged, and spiro ring systems having aromatic and non-aromatic rings that have no ring heteroatoms, the term “Aryl” applies when the point of attachment is at an aromatic carbon atom (e.g., 5,6,7,8 tetrahydronaphthalene-2-yl is an aryl group as its point of attachment is at the 2-position of the aromatic phenyl ring).

“Cycloalkyl” refers to a saturated or partially saturated cyclic group, which may have from 3 to 14 carbon atoms and no ring heteroatoms and having a single ring or multiple rings including fused, bridged, and spiro ring systems. For multiple ring systems having aromatic and non-aromatic rings that have no ring heteroatoms, the term “cycloalkyl” applies when the point of attachment is at a non-aromatic carbon atom (e.g., 5,6,7,8,-tetrahydronaphthalene-5-yl). The term “cycloalkyl” includes cycloalkenyl groups, such as adamantyl, cyclopropyl, cyclobutyl, cyclopentyl, cyclooctyl, and cyclohexenyl. The term “cycloalkenyl” is sometimes employed to refer to a partially saturated cycloalkyl ring having at least one site of >C═C<ring unsaturation.

“Halo” or “halogen” refers to fluoro, chloro, bromo, and iodo.

“Haloalkyl” refers to substitution of an alkyl group with 1 to 5, or in some embodiments, from 1 to 3 halo groups.

“Heteroaryl” refers to an aromatic group, which may have from 1 to 14 carbon atoms and 1 to 6 heteroatoms selected from oxygen, nitrogen, and sulfur and includes single ring (e.g., imidazolyl) and multiple ring systems (e.g., benzimidazol-2-yl and benzimidazol-6-yl). For multiple ring systems, including fused, bridged, and spiro ring systems having aromatic and non-aromatic rings, the term “heteroaryl” applies if there is at least one ring heteroatom and the point of attachment is at an atom of an aromatic ring (e.g., 1,2,3,4-tetrahydroquinolin-6-yl and 5,6,7,8-tetrahydroquinolin-3-yl). In some embodiments, the nitrogen and/or the sulfur ring atom(s) of the heteroaryl group are optionally oxidized to provide for the N oxide (N→O), sulfinyl, or sulfonyl moieties. Examples of heteroaryl groups include, but are not limited to, pyridyl, furanyl, thienyl, thiazolyl, isothiazolyl, triazolyl, imidazolyl, imidazolinyl, isoxazolyl, pyrrolyl, pyrazolyl, pyridazinyl, pyrimidinyl, purinyl, phthalazyl, naphthylpryidyl, benzofuranyl, tetrahydrobenzofuranyl, isobenzofuranyl, benzothiazolyl, benzoisothiazolyl, benzotriazolyl, indolyl, isoindolyl, indolizinyl, dihydroindolyl, indazolyl, indolinyl, benzoxazolyl, quinolyl, isoquinolyl, quinolizyl, quianazolyl, quinoxalyl, tetrahydroquinolinyl, isoquinolyl, quinazolinonyl, benzimidazolyl, benzisoxazolyl, benzothienyl, benzopyridazinyl, pteridinyl, carbazolyl, carbolinyl, phenanthridinyl, acridinyl, phenanthrolinyl, phenazinyl, phenoxazinyl, phenothiazinyl, and phthalimidyl.

“Heterocyclic” or “heterocycle” or “heterocycloalkyl” or “heterocyclyl” refers to a saturated or partially saturated cyclic group, which may have from 1 to 14 carbon atoms and from 1 to 6 heteroatoms selected from nitrogen, sulfur, or oxygen and includes single ring and multiple ring systems including fused, bridged, and spiro ring systems. For multiple ring systems having aromatic and/or non-aromatic rings, the terms “heterocyclic”, “heterocycle”, “heterocycloalkyl”, or “heterocyclyl” apply when there is at least one ring heteroatom and the point of attachment is at an atom of a non-aromatic ring (e.g., decahydroquinolin-6-yl). In some embodiments, the nitrogen and/or sulfur atom(s) of the heterocyclic group are optionally oxidized to provide for the N oxide, sulfinyl, sulfonyl moieties. Examples of heterocyclyl groups include, but are not limited to, azetidinyl, tetrahydropyranyl, piperidinyl, N-methylpiperidin-3-yl, piperazinyl, N-methylpyrrolidin-3-yl, 3-pyrrolidinyl, 2-pyrrolidon-1-yl, morpholinyl, thiomorpholinyl, imidazolidinyl, and pyrrolidinyl.

It should be understood that the aforementioned definitions encompass unsubstituted groups, as well as groups substituted with one or more other groups as is known in the art. For example, an alkyl, alkenyl, alkynyl, aryl, heteroaryl, cycloalkyl, or heterocyclyl group may be substituted with from 1 to 8, in some embodiments from 1 to 5, in some embodiments from 1 to 3, and in some embodiments, from 1 to 2 substituents selected from alkyl, alkenyl, alkynyl, alkoxy, acyl, acylamino, acyloxy, amino, quaternary amino, amide, imino, amidino, aminocarbonylamino, amidinocarbonylamino, aminothiocarbonyl, aminocarbonylamino, aminothiocarbonylamino, aminocarbonyloxy, aminosulfonyl, aminosulfonyloxy, aminosulfonylamino, aryl, aryloxy, arylthio, azido, carboxyl, carboxyl ester, (carboxyl ester)amino, (carboxyl ester)oxy, cyano, cycloalkyl, cycloalkyloxy, cycloalkylthio, epoxy, guanidino, halo, haloalkyl, haloalkoxy, hydroxy, hydroxyamino, alkoxyamino, hydrazino, heteroaryl, heteroaryloxy, heteroarylthio, heterocyclyl, heterocyclyloxy, heterocyclylthio, nitro, oxo, oxy, thione, phosphate, phosphonate, phosphinate, phosphonamidate, phosphorodiamidate, phosphoramidate monoester, cyclic phosphoramidate, cyclic phosphorodiamidate, phosphoramidate diester, sulfate, sulfonate, sulfonyl, substituted sulfonyl, sulfonyloxy, thioacyl, thiocyanate, thiol, alkylthio, etc., as well as combinations of such substituents.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to an article that contains a glass substrate and a coating provided on a surface of the substrate that is capable of being heat treated. The coating includes at least one metal oxide containing zinc oxide that is present relatively near the surface of the coating opposite the surface adjacent the glass substrate. In addition, the coating includes a relatively roughened surface that allows for an increased active surface area. The present inventors have discovered that such an increased active surface area can provide improved antimicrobial properties and/or self-cleaning properties. In addition, by allowing zinc to provide the antimicrobial function, the coated glass substrate of the present invention can be heat treatable and provide a resulting glass substrate with antimicrobial properties.

The coated substrate of the present invention exhibits improved antimicrobial properties because of the distribution of the zinc of the zinc oxide within the coating. In particular, by having a greater concentration of exposed zinc, the antimicrobial properties can be improved. In this regard, at least some of the zinc oxide may be found on or near an outer surface of the coating, wherein the outer surface of the coating is opposite the surface adjacent and contacting the glass substrate. For instance, the zinc of the zinc oxide may be present in the coating in an amount of about 5 wt. % or more, such as about 10 wt. % or more, such as about 13 wt. % or more, such as about 15 wt. % or more, such as about 20 wt. % or more to about 50 wt. % or less, such as about 40 wt. %% or less, such as about 30 wt. % or less, such as about 20 wt. % or less as determined according to XPS.

In addition to the zinc oxide, the metal oxide may also include titanium dioxide. Without intending to be limited by theory, it is believed that the titanium dioxide can be employed to serve as a self-cleaning additive. When present, such titanium may also be found on or near an outer surface of the coating, wherein the outer surface of the coating is opposite the surface adjacent and contacting the glass substrate. For instance, the titanium of the titanium dioxide may be present in the coating in an amount of about 0.5 wt. % or more, such as about 1 wt. % or more, such as about 1.5 wt. % or more, such as about 2 wt. % or more, such as about 2.5 wt. % or more to about 10 wt. % or less, such as about 7.5 wt. % or less, such as about 5 wt. % or less, such as about 4 wt. % or less, such as about 3 wt. % or less, such as about 2 wt. % or less as determined according to XPS.

As indicated herein, the use of such metal oxides may provide a coating having a roughened surface. The roughened surface allows for an increase in surface area and thus an increase in the amount of zinc and/or titanium that is exposed for providing an antimicrobial effect. In this regard, the coating may have a surface roughness of about 5 nm or more, such as about 10 nm or more, such as about 15 nm or more, such as about 25 nm or more, such as about 50 nm or more, such as about 100 nm or more, such as about 250 nm or more, such as about 500 nm or more, such as about 600 nm or more, such as about 750 nm or more to about 1,500 nm or less, such as about 1,250 nm or less, such as about 1,000 nm or less, such as about 900 nm or less, such as about 750 nm or less, such as about 500 nm or less, such as about 400 nm or less, such as about 200 nm or less, such as about 150 nm or less, such as about 100 nm or less, such as about 75 nm or less, such as about 50 nm or less, such as about 25 nm or less. The surface roughness may be measured using a profilometer such as an AFM. In addition, the aforementioned surface area may be a profile roughness. In another embodiment, the roughness may be an area roughness. In addition, the aforementioned roughness may be an arithmetic average in one embodiment. Alternatively, it may also refer to a geometric average.

As indicated above, the distribution of metal oxide(s) and surface roughness may allow for improved antimicrobial properties. For example, the coating may have antimicrobial properties such that glass coated according to the present disclosure as compared to traditional glass exhibits a decrease in bacteria of at least about 85%, such as at least about 87%, such as at least about 90%, such as at least about 92%, such as at least about 94%, such as at least about 96%, such as at least about 98%, such as at least about 99%, such as at least about 99.9%. Further, the coating may exhibit a Log₁₀ reduction in bacteria of at least about 1, such as at least about 2, such as at least about 3, such as at least about 3.5, such as at least about 4, such as at least about 4.5, such as at least about 5, such as at least about 5.5, such as at least about 6. The Log₁₀ reduction may be about 8 or less, such as less than about 7.5, such as less than about 7, such as less than about 6.5, such as less than about 6. Such antimicrobial tests can be performed in accordance with JIS Z2801.

A tempered coating and article according to the present disclosure may also exhibit enhanced processability. The tempered article may have a cross-hatch adhesion as determined in accordance with ASTM D3359-09 of 3B or higher, such as 4B or higher, such as 5B. The cross-hatch adhesion provides an assessment of the adhesion of the coating to the substrate by applying and removing pressure-sensitive tape over cutes made in the coating. In addition, the coating may have a stud pull strength of about 200 pounds per square inch or greater, such as about 300 pounds per square inch or greater, such as about 400 pounds per square inch or greater, such as about 450 pounds per square inch or greater, such as about 500 pounds per square inch or greater, such as about 600 pounds per square inch or greater, such as about 1,000 pounds per square inch or less, such as about 900 pounds per square inch or less, such as about 800 pounds per square inch or less.

A. Substrate

The glass substrate typically has a thickness of from about 0.1 to about 15 millimeters, in some embodiments from about 0.5 to about 10 millimeters, and in some embodiments, from about 1 to about 8 millimeters. The glass substrate may be formed by any suitable process, such as by a float process, fusion, down-draw, roll-out, etc. Regardless, the substrate is formed from a glass composition having a glass transition temperature that is typically from about 500° C. to about 700° C. The composition, for instance, may contain silica (SiO₂), one or more alkaline earth metal oxides (e.g., magnesium oxide (MgO), calcium oxide (CaO), barium oxide (BaO), and strontium oxide (SrO)), and one or more alkali metal oxides (e.g., sodium oxide (Na₂O), lithium oxide (Li₂O), and potassium oxide (K₂O)).

SiO₂ typically constitutes from about 55 mol. % to about 85 mol. %, in some embodiments from about 60 mol. % to about 80 mol. %, and in some embodiments, from about 65 mol. % to about 75 mol. % of the composition. Alkaline earth metal oxides may likewise constitute from about 5 mol. % to about 25 mol. %, in some embodiments from about 10 mol. % to about 20 mol. %, and in some embodiments, from about 12 mol. % to about 18 mol. % of the composition. In particular embodiments, MgO may constitute from about 0.5 mol. % to about 10 mol. %, in some embodiments from about 1 mol. % to about 8 mol. %, and in some embodiments, from about 3 mol. % to about 6 mol. % of the composition, while CaO may constitute from about 1 mol. % to about 18 mol. %, in some embodiments from about 2 mol. % to about 15 mol. %, and in some embodiments, from about 6 mol. % to about 14 mol. % of the composition. Alkali metal oxides may constitute from about 5 mol. % to about 25 mol. %, in some embodiments from about 10 mol. % to about 20 mol. %, and in some embodiments, from about 12 mol. % to about 18 mol. % of the composition. In particular embodiments, Na₂O may constitute from about 1 mol. % to about 20 mol. %, in some embodiments from about 5 mol. % to about 18 mol. %, and in some embodiments, from about 8 mol. % to about 15 mol. % of the composition.

Of course, other components may also be incorporated into the glass composition as is known to those skilled in the art. For instance, in certain embodiments, the composition may contain aluminum oxide (Al₂O₃). Typically, Al₂O₃ is employed in an amount such that the sum of the weight percentage of SiO2 and Al2O3 does not exceed 85 mol. %. For example, Al₂O₃ may be employed in an amount from about 0.01 mol. % to about 3 mol. %, in some embodiments from about 0.02 mol. % to about 2.5 mol. %, and in some embodiments, from about 0.05 mol. % to about 2 mol. % of the composition. In other embodiments, the composition may also contain iron oxide (Fe₂O₃), such as in an amount from about 0.001 mol. % to about 8 mol. %, in some embodiments from about 0.005 mol. % to about 7 mol. %, and in some embodiments, from about 0.01 mol. % to about 6 mol. % of the composition. Still other suitable components that may be included in the composition may include, for instance, titanium dioxide (TiO₂), chromium (III) oxide (Cr₂O₃), zirconium dioxide (ZrO₂), ytrria (Y₂O₃), cesium dioxide (CeO₂), manganese dioxide (MnO₂), cobalt (II, III) oxide (Co₃O₄), metals (e.g., Ni, Cr, V, Se, Au, Ag, Cd, etc.), and so forth.

B. Coating

As indicated above, a coating is provided on one or more surfaces of the substrate. For example, the glass substrate may contain first and second opposing surfaces, and the coating may thus be provided on the first surface of the substrate, the second surface of the substrate, or both. In one embodiment, for instance, the coating is provided on only the first surface. In such embodiments, the opposing second surface may be free of a coating or it may contain a different type of coating. Of course, in other embodiments, the coating of the present invention may be present on both the first and second surfaces of the glass substrate. In such embodiments, the nature of the coating on each surface may be the same or different.

Additionally, the coating may be employed such that it substantially covers (e.g., 95% or more, such as 99% or more) the surface area of a surface of the glass substrate. However, it should be understood that the coating may also be applied to cover less than 95% of the surface area of a surface of the glass substrate. For instance, the coating may be applied on the glass substrate in a decorative manner.

The coating may contain any number of different materials. For example, the coating may contain a binder and at least one metal oxide containing zinc oxide. As provided below, the binder may be one produced via sol gel method or may include an interpenetrating polymer network. As also provided below, the zinc oxide may be obtained from different sources, such as via a reaction using another zinc compound (e.g., zinc acetate) or a glass frit.

i. Binder

The coating disclosed herein can be produced using any binder generally known in the art. For instance, the binder may include one produced via sol-gel by employing an alkoxide. Alternatively, the binder may include an interpenetrating polymer network of at least two crosslinked polymers.

In one embodiment, the binder may be formed via sol-gel. For instance, the binder may be formed from a metal and/or non-metal alkoxide compound. In particular, such alkoxides may be employed to form a polymerized (or condensed) alkoxide coating. For instance, the compounds may undergo a hydrolysis reaction and a condensation reaction. Then, the solvent is removed by heating or other means to provide the coating.

Generally, an alkoxide may have the following general formula

M^{x+}(OR)⁻ₓ

wherein,
x is from 1 to 4;
R is an alkyl or cycloalkyl; and
M is a metal or a non-metal cation.

While R, M, and x may be generally selected accordingly, in certain embodiments, they may be selected according to the following.

As indicated above, “x” may be from 1 to 4. However, “x” may be selected based upon the valence of the chosen metal or non-metal cation. As indicated above, “x” may be 1, 2, 3, or 4. In one embodiment, “x” is 1 while in other embodiments, “x” may be 2. In another embodiment, “x” may be 3 while in another embodiment “x” may be 4.

Similarly, “R” may be selected based upon the desired characteristics, including the desired stereospecificity of the resulting alkoxide. For instance, “R” may be an alkyl or cycloalkyl. In this regard, such alkyl may be C₁ or greater, such as a C₁-C₆, such as a C₁-C₃, such as a C₂-C₃. Meanwhile, such cycloalkyl may be C₃ or greater, such as a C₃-C₆, such as a C₄-C₆, such as a C₄-C₅. When “R” is an alkyl, “R” may be selected to be a methyl, ethyl, butyl, propyl, or isopropyl group. In one embodiment, “R” may be a propyl group, such as an isopropyl group. When R is a cycloalkyl, “R” may be a cyclopropyl, cyclobutyl, cyclopentyl, or cyclohexyl group.

As indicated above, “M” may be a metal cation or a non-metal cation. In one embodiment, “M” may be a metal cation. The metal may be a Group IA, IIA, IIIA, IVA, VA, VIA, IB, IIB IIIB, IVB, VB, VIB, VIIB, or VIIIB metal. For instance, “M”, while not necessarily limited to the following, may be aluminum, cobalt, copper, gallium, germanium, hafnium, iron, lanthanum, molybdenum, nickel, niobium, rhenium, scandium, silicon, sodium, tantalum, tin, titanium, tungsten, or zirconium. In one particular embodiment, “M” may be copper, aluminum, zinc, zirconium, silicon or titanium. In one embodiment, “M” may include any combination of the aforementioned. For instance, the alkoxide may include a combination of alkoxides including copper, aluminum, zinc, zirconium, silicon and titanium. In one embodiment, “M” may include at least silicon. In another embodiment, “M” may be a non-metal cation, such as a metalloid as generally known in the art.

In yet further embodiments, alkoxides may be selected according to the following exemplary embodiments. For example, exemplary alkoxides may include Cu(OR), Cu(OR)₂, Al(OR)₃, Zr(OR)₄, Si(OR)₄, Ti(OR)₄, and Zn(OR)₂, wherein R is a C₁ or greater alkyl group. For instance, the metal alkoxide may include, but is not limited to, aluminum butoxide, titanium isopropoxide, titanium propoxide, titanium butoxide, zirconium isopropoxide, zirconium propoxide, zirconium butoxide, zirconium ethoxide, tantalum ethoxide, tantalum butoxide, niobium ethoxide, niobium butoxide, tin t-butoxide, tungsten (VI) ethoxide, germanium, germanium isopropoxide, hexyltrimethoxylsilane, tetraethoxysilane, and so forth, and in a more particular embodiment may be titanium isopropoxide, zirconium n-propoxide, aluminum s-butoxide, copper propoxide, and/or tetraethoxysilane.

In particular, the alkoxide compound may be an organoalkoxysilane compound. Examples of organoalkoxysilane compounds include those having the following general formula:

R⁵ₐSi(OR⁶)₄₋ₐ

wherein,

a is from 0 to 3, and in some embodiments, from 0 to 1;

R⁵ is an alkyl, alkenyl, aryl, heteroaryl, cycloalkyl, heterocyclyl, halo, or haloalkyl; and

R⁶ is an alkyl.

In certain embodiments, “a” is 0 such that that the organosilane compound is considered an organosilicate. One example of such a compound is tetraethyl orthosilicate (Si(OC₂H₅)₄). In other embodiments, “a” is 1 such that the organosilane compound is considered a trialkoxysilane compound. In one embodiment, for instance, R5 in the trialkoxysilane compound may be an alkyl, aryl, or haloalkyl (e.g., fluoroalkyl). Such group may have at least 1 carbon atom, such as at least 2 carbon atoms, such as at least 3 carbon atoms and may have 25 carbon atoms or less, such as 20 carbon atoms or less, such as 10 carbon atoms or less, such as 5 carbon atoms or less. Several examples of such trialkoxysilane compounds include, for instance, ethyltrimethoxysilane (CH₃CH₂Si(OCH₃)₃), ethyltriethoxysilane (CH₃CH₂Si(OCH₂CH₃)₃), phenyltrimethoxysilane (phenyl-(OCH₃)₃), phenyltriethoxysilane (phenyl-(OCH₂CH₃)₃), hexyltrimethoxylsilane (CH₃(CH₂)₅Si(OCH₃)₃), hexyltriethoxylsilane (CH₃ (CH₂)₅Si(OCH₂CH₃)₃), heptadecapfluoro-1,2,2-tetrahydrodecyltrimethoxysilane (CF₃(CF₂)₇(CH₂)₂Si(OCH₃)₃), 3-glycidoxypropyltrimethoxysilane (CH₂(O)CH—CH₂O—(CH₂)₃—Si(OCH₃)₃), etc., as well as combinations thereof.

Any of a variety of curing mechanisms may generally be employed to form the silicon-containing resin. For instance, the alkoxysilanes can undergo a hydrolysis reaction to convert the OR6 groups into hydroxyl groups. Thereafter, the hydroxyl groups can undergo a condensation reaction to form a siloxane functional group. In general, reactions may occur via an SN2 mechanism in the presence of an acid. For instance, silanes may be hydrolyzed and then condensed to form the crosslinked network. In addition, the hydrolyzed silanes may also react with silica particles, such as silica nanoparticles, when employed.

To initiate the reaction, the organosilane compound may initially be dissolved in a solvent to form a solution. Particularly suitable are organic solvents, such as hydrocarbons (e.g., benzene, toluene, and xylene); ethers (e.g., tetrahydrofuran, 1,4-dioxane, and diethyl ether); ketones (e.g., methyl ethyl ketone); halogen-based solvents (e.g., chloroform, methylene chloride, and 1,2-dichloroethane); alcohols (e.g., methanol, ethanol, isopropyl alcohol, and isobutyl alcohol); and so forth, as well as combinations of any of the foregoing. Alcohols are particularly suitable for use in the present invention. The concentration of the organic solvent within the solution may vary, but is typically employed in an amount of from about 70 wt. % to about 99 wt. %, in some embodiments from about 80 wt. % to about 98 wt. %, and in some embodiments, from about 85 wt. % to about 97 wt. % of the solution. Organosilane compounds may likewise constitute from about 1 wt. % to about 30 wt. %, in some embodiments from about 2 wt. % to about 20 wt. %, and in some embodiments, from about 3 wt. % to about 15 wt. % of the solution.

In another embodiment, the binder may be produced as an interpenetrating network. The interpenetrating network may include any number of resins. For instance, the network may include at least two polymer resins, such as at least three polymer resins, each having a chemical composition different from the other.

The interpenetrating network can be a fully-interpenetrating network or a semi-interpenetrating network. In one embodiment, the interpenetrating network is a fully-interpenetrating network such that the all of the resins of the network are crosslinked. That is, all of the resins of the binder are crosslinked to form the interpenetrating network. In this regard, the polymer chains of at least one respective resin are interlocked with the polymer chains of another respective resin such that they may not be separated without breaking any chemical bonds.

The interpenetrating network can also be a semi-interpenetrating network. In such instance, the network contains at one resin whose polymer chains are not interlocked with the polymer chains of a crosslinked resin such that the former polymers chains can theoretically be separated without breaking any chemical bonds.

In addition, the interpenetrating network may include a combination of an organic crosslinked network and an inorganic crosslinked network. For instance, at least one of the crosslinked resins may form an organic crosslinked network while at least one of the crosslinked resins may form an inorganic crosslinked resin. By organic crosslinked resin, it is meant that the polymerizable compound is a carbon-based compound. Meanwhile, by inorganic crosslinked resin, it is meant that the polymerizable compound is not a carbon-based compound. For instance, the polymerizable compound may be a silicon-based compound. In one embodiment, the interpenetrating network may include at least two organic crosslinked networks and one inorganic crosslinked network.

As described herein, an interpenetrating network can be synthesized using any method known in the art. For instance, a formulation containing all of the polymerizable compounds as well as any other reactants, reagents, and/or additives (e.g., initiators, catalysts, etc.) can be applied to a substrate and cured such that the simultaneous polymerization and crosslinking of the respective resins forms the interpenetrating network. In this regard, the respective crosslinked resins may form at substantially the same time. It should be understood that the aforementioned polymerizable compounds may include individual monomers and oligomers or pre-polymers.

An interpenetrating network can also exhibit certain properties that distinguish it from a simple blend of resins. The interpenetrating network may exhibit a glass transition temperature that is between or intermediate the glass transition temperature of any two of the first crosslinked resin, the second crosslinked resin, and the third resin. For instance, the interpenetrating network may have a glass transition temperature of from 0° C. to 300° C., such as from 10° C. to 250° C., such as from 20° C. to 200° C., such as from 30° C. to 180° C. The glass transition temperature may be measured by differential scanning calorimetry according to ASTM E1356. In addition, for other properties that may exhibit a bimodal distribution or a trimodal distribution due to the presence of a simple mixture of two resins or three resins, respectively, such properties of the interpenetrating network may exhibit a unimodal distribution.

In general, the resins of the binder may be a thermoplastic resin or a thermoset resin. At least one of the resins in the binder is a thermoset resin such that it can be cured/crosslinked. For instance, by curing, the thermoset resin can become hardened and allow for the formation of a coating. The thermoset resin is generally formed from at least one crosslinkable or polymerizable resin, such as a (meth)acrylic resin, (meth)acrylamide resin, alkyd resin, phenolic resin, amino resin, silicone resin, epoxy resin, polyol resin, etc. As used herein, the term “(meth)acrylic” generally encompasses both acrylic and methacrylic resins, as well as salts and esters thereof, e.g., acrylate and methacrylate resins. In one embodiment, at least two of the resins may be thermoset resins. In one embodiment, two of the resins may be thermoset resins while a third resin may be a thermoplastic resin. In another embodiment, at least three of the resins may be thermoset resins upon being crosslinked.

In this regard, the interpenetrating network may contain a crosslinked polyol resin. The crosslinked polyol resin can be obtained by reacting or crosslinking polyols. In general, polyols contain two or more hydroxyl groups (i.e., defined as an —OH group wherein the —OH group of a carboxyl group is not considered a hydroxyl group). In general, polyols can be non-polymeric polyols or polymeric polyols. Examples of such polyols may include, for instance, a diol compound, a polyether polyol, a polyester polyol, a polycarbonate polyol, a polyacrylate polyol, a polyurethane polyol, a polysiloxane polyol, a phenolic polyol, a sugar alcohol, a dendritic polyol, and so forth. In one embodiment, the polyol may be a diol compound, a polyether polyol, a sugar alcohol, and/or a dendritic polyol. However, it should be understood that the polyol may not be limited to the aforementioned and may include any polyol known in the art that can be polymerized and/or crosslinked.

As indicated above, the polyol may include a diol compound. For instance, the polyol may be an ethylene glycol, diethylene glycol, propylene glycol, dipropylene glycol, butanediol, pentanediol, hexanediol, heptanediol, octanediol, nonanediol, decanediol, etc. While the aforementioned are diol compounds containing two hydroxyl groups, it should be understood that compounds containing additional hydroxyl groups may also be employed.

In one embodiment, the polyol may include a polyurethane polyol. The polyurethane polyol may be formed by reacting one or more isocyanate groups with a polyol.

In one embodiment, the polyol may include a polyether polyol. The polyether polyol may include an ethoxylation or a propoxylation product of water or a diol. The polyether polyol may be polyethylene glycol, polypropylene glycol, or a combination thereof. In one embodiment, the polyether polyol may be polyethylene glycol. In another embodiment, the polyether polyol may be polypropylene glycol. For instance, the propylene glycol may be a monopropylene glycol, dipropylene glycol and/or a tripropylene glycol.

Additionally, the polyol may include a polyester polyol. The polyester polyol may be made by a polycondensation reaction of an acid or corresponding anhydride with a polyhydric alcohol. Suitable acids for example include, but are not limited to, benzoic acid, maleic acid, adipic acid, phthalic acid, isophthalic acid, terephthalic acid and sebacic acid as well as their corresponding anhydrides, and dimeric fatty acids and trimeric fatty acids and short oils. Suitable polyhydric alcohols include, but are not limited to, ethylene glycol, propylene glycol, diethylene glycol, 1,4-butanediol, 1,6-hexane diol, 2,2-dimethyl-1,3-propanediol, neopentyl glycol, tetraethylene glycol, polycarbonate diols, trimethylolethane, trimethylolpropane, glycerol, 1,4-cyclohexanediol, 1,4-cyclohexanedimethanol, and glycerol.

In another embodiment, the polyol may include a polyacrylate polyol. The polyacrylate polyol may be made by a copolymerization reaction of a hydroxyalkyl(meth)acrylate monomer, such as, for example, a hydroxy C1-C8 alkyl (meth)acrylate, with an acrylate monomer, such as, for example, a C1-C10 alkyl acrylate and a cyclo C6-C12 alkyl acrylate, or with a methacrylate monomer, such as, for example, a C1-C10 alkyl methacrylate and a cyclo C6-C12 alkyl methacrylate, or with a vinyl monomer, such as, for example, styrene, α-methylstyrene, vinyl acetate, vinyl versatate, or with a mixture of two or more of such monomers. Suitable hydroxyalkyl(meth)acrylate monomers include for example, hydroxyethyl acrylate, hydroxypropyl acrylate, hydroxyethyl methacrylate, hydroxypropyl methacrylate. Suitable alkyl (meth)acrylate monomers include, for example, methyl methacrylate, ethyl methacrylate, butyl methacrylate, butyl acrylate, ethylhexyl methacrylate, isobornyl methacrylate. Suitable polyacrylate polyols include, for example, hydroxy(C2-C8)alkyl (meth)acrylate-co-(C2-C8)alkyl (meth)acrylate copolymers.

The polyol may also include a sugar alcohol. For instance, the sugar alcohol may be a sucrose based alcohol. For instance, the polyol may be a sorbitol or a sorbitol based polyol. The sorbitol may be an ethoxylated and/or propoxylated sorbitol.

In a further embodiment, the polyol may be a dendritic polyol. Like other polyols, the dendritic polyols contain reactive hydroxyl groups with can react with other functional groups. Generally, such dendritic polyols can offer a large number of primary hydroxyl groups along a densely branched polymer backbone. The dendritic polyol may be a carbon based dendritic polyol or a silicon based dendritic polyol or a combination thereof. That is, the base polyol utilized for the formation of the dendritic polyol may include carbon, silicon, or a combination thereof. In one embodiment, the base polyol includes carbon. In another embodiment, the base polyol includes a combination of a silicon and carbon (i.e., a carbosilane). However, it should be understood that the base polyol may also include other atoms, such as another oxygen atom outside of the hydroxyl group.

In addition, to form the dendritic polyol, the base polyol should be a branched structure. For instance, from a central atom, there should be at least three, such as at least four substituent groups or branches that extend therefrom and allow the formation of a dendritic structure. In addition, the dendritic polyol may have an average degree of branching of more than zero and less than or equal to 1, such as from 0.2 to 0.8. Generally, according to definition, strictly linear polyols have a degree of branching of zero and ideally dendritic polyols have a degree of branching of 1.0. The average degree of branching may be determined by ¹³C-NMR spectroscopy.

In addition, the dendritic polyol may be a polyether polyol and/or a polyester polyol. In one embodiment, the dendritic polyol may be a polyether polyol. In another embodiment, the dendritic polyol may be a polyester polyol. In another embodiment, the dendritic polyol may be a combination of a polyether poly and a polyester polyol.

The dendritic polyol has at least 2, such as at least 3, such as at least 4, such as at least 5, such as at least 6, such as at least 8, such as at least 10, such as at least 15, such as at least 20, such as at least 30, such as at least 50, such as at least 100 terminal hydroxyl groups to 1000 or less, such as 500 or less, such as 100 or less, such as 75 or less, such as 50 or less, such as 25 or less, such as 15 or less, such as 10 or less terminal hydroxyl groups. The dendritic polyol has a molecular weight of at least 500 g/mol, such as at least 1,000 g/mol, such as at least 1,500 g/mol, such as at least 2,000 g/mol, such as at least 2,500 g/mol, such as at least 3,000 g/mol, such as at least 4,000 g/mol, such as at least 5,000 g/mol, such as at least 6,000 g/mol, such as at least 10,000 g/mol to 100,000 g/mol or less, such as 75,000 g/mol or less, such as 50,000 g/mol or less, such as 25,000 g/mol or less, such as 15,000 g/mol or less, such as 10,000 g/mol or less, such as 7,500 g/mol or less, such as 6,000 g/mol or less, such as 5,000 g/mol or less. While not necessarily limited, the dendritic polyol may be any of those available under the name Boltorn™.

When such dendritic polyols are employed, crosslinked networks can be obtained. For instance, crosslinked networks can be obtained via a condensation reaction with any silanes, in particular hydrolyzed silanes present in the formulation. In addition, reactions may occur with a melamine resin. In this regard, the dendritic polyol may serve as a crosslinking agent. In particular, a carbocation intermediate may be formed in the melamine resin. Thereafter, condensation may occur between the melamine resin and the dendritic polyol. Such reactions may occur via SN1 mechanisms. In addition to such reactions, the dendritic polyol may also react with the glass substrate. That is, the dendritic polyol may react with hydroxyl groups present on the glass substrate. Such reaction may improve the adhesive strength of the coating on the glass substrate thereby resulting in improved stud pull and cross-hatch properties.

Any of a variety of curing mechanisms may generally be employed to form the crosslinked polyol resin. In certain embodiments, for instance, a crosslinking agent may be employed to help facilitate the formation of crosslink bonds. For example, an isocyanate crosslinking agent may be employed that can react with amine or hydroxyl groups on the polyol polymerizable compound. The isocyanate crosslinking agent can be a polyisocyanate crosslinking agent. In addition, the isocyante crosslinking agent can be aliphatic (e.g., hexamethylene diisocyanate, isophorone diisocyanate, etc.) and/or aromatic (e.g., 2,4 tolylene diisocyanate, 2,6-tolylene diisocyanate, etc.). The reaction can provide urea bonds when reacting with an amine group and urethane bonds when reacting with a hydroxyl group. In this regard, the crosslinked polymer or resin may be a polyurethane.

In yet another embodiment, a melamine crosslinking agent may be employed that can react with hydroxyl groups on the polyol polymerizable compound to form the crosslink bonds. Suitable melamine crosslinking agents may include, for instance, resins obtained by addition-condensation of an amine compound (e.g., melamine, guanamine, or urea) with formaldehyde. Particularly suitable crosslinking agents are fully or partially methylolated melamine resins, such as hexamethylol melamine, pentamethylol melamine, tetramethylol melamine, etc., as well as mixtures thereof. Such reactions can provide ether bonds when reacting a hydroxyl group of the polyol polymerizable compound with a hydroxyl group of the amine (e.g., melamine) crosslinking agent. In this regard, the crosslinked polymer or resin may be a polyurethane.

In one embodiment, the first crosslinked resin is a crosslinked polyol resin with urethane bonds formed by the polyol and the crosslinking agent. In this regard, the polyol is crosslinked with an isocyanate crosslinking agent. In another embodiment, the first crosslinked resin is a crosslinked polyol resin with ether bonds formed by the polyol and the crosslinking agent. In this regard, the polyol is crosslinked with an amine crosslinking agent containing hydroxyl groups, such as a melamine-formaldehyde crosslinking agent.

In general, reactions may occur via an SN1 mechanism in the presence of an acid catalyst (e.g., p-toluene sulfonic acid). For instance, when a melamine formaldehyde crosslinking agent is employed, a proton can be attacked by an oxygen atom (in —CH₂OCH₃) located in the melamine formaldehyde to generate a carbocation intermediate with —CH₃OH remaining as the by-product. Then, the nucleophilic oxygen in the polyol can attack the electrophilic carbocation intermediate to create a chemical bond between the melamine-formaldehyde and the polyol.

In one embodiment, the binder may also contain an acrylate resin. The acrylate resin may be one derived from acrylic acid, methacrylic acid, or a combination thereof. For instance, the acrylate monomer includes, but is not limited to, methyl acrylate, ethyl acrylate, n-propyl acrylate, i-propyl acrylate, n-butyl acrylate, s-butyl acrylate, i-butyl acrylate, t-butyl acrylate, n-amyl acrylate, amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof.

In one embodiment, the acrylate monomers may be diacrylate monomers. For instance, the acrylate monomers may be diacrylate monomers including, but not limited to, methyl diacrylate, ethyl diacrylate, n-propyl diacrylate, i-propyl diacrylate, n-butyl diacrylate, s-butyl diacrylate, i-butyl diacrylate, t-butyl diacrylate, n-amyl diacrylate, i-amyl diacrylate, isobornyl diacrylate, n-hexyl diacrylate, 2-ethylbutyl diacrylate, 2-ethylhexyl diacrylate, n-octyl diacrylate, n-decyl diacrylate, methylcyclohexyl diacrylate, cyclopentyl diacrylate, cyclohexyl diacrylate, methyl dimethacrylate, ethyl dimethacrylate, 2-hydroxyethyl dimethacrylate, n-propyl dimethacrylate, n-butyl dimethacrylate, i-propyl dimethacrylate, i-butyl dimethacrylate, n-amyl dimethacrylate, n-hexyl dimethacrylate, i-amyl dimethacrylate, s-butyl-dimethacrylate, t-butyl dimethacrylate, 2-ethylbutyl dimethacrylate, methylcyclohexyl dimethacrylate, cinnamyl dimethacrylate, crotyl dimethacrylate, cyclohexyl dimethacrylate, cyclopentyl dimethacrylate, 2-ethoxyethyl dimethacrylate, isobornyl dimethacrylate, etc., as well as combinations thereof.

In general, the acrylate monomers may be aliphatic monomers. For instance, the monomers may be used to form aliphatic oligomers. In this regard, in one embodiment, the aliphatic monomers or oligomers may not contain any aromatic components.

The monomers may also include any derivatives of the aforementioned. In general, these monomers can be referred to as the polymerizable compounds of the acrylate resins. In a further embodiment, the monomers may be polymerized, including by graft, block, or random polymerization, with a non-acrylate monomer to form an acrylate co-polymer. As used herein, a (meth)acrylate copolymer can mean either a methacrylate copolymer or an acrylate copolymer, either in their modified or unmodified form. For example, such a copolymer may comprise any of the acrylate monomers contained herein copolymerized with polyesters, polyvinyl acetates, polyurethanes, polystyrene, or combinations thereof. In one example, the co-polymer may include a polystyrene copolymer and more particularly, a meth-methylacrylate and polystyrene copolymer.

In one embodiment, the acrylate resin is made from monomers including the monoacrylates and the diacrylates. In another embodiment, the monomers consist of the diacrylate monomers.

The acrylate resins may also further include a glycidyl functional group. For instance, the acrylate monomer may be a glycidyl group containing acrylate monomer such that the glycidyl group is not part of the backbone but instead imparts functionality to the acrylate monomer.

In general, these acrylate resins can be synthesized according to any method known in the art. The acrylate resins can be formed in one reaction step or in more than one reaction step. If multiple steps are employed, a prepolymer may be formed initially which can then undergo further reactions to synthesize the acrylate resins disclosed herein. Also, the acrylate resins can be synthesized using UV radiation.

In addition, the glycidyl or epoxy groups of the resins may be crosslinked. Crosslinking may be performed using any method and using any crosslinking agent generally employed in the art. The crosslinking agent may be an amine, an amide, an acrylate, or a combination thereof. In one embodiment, the crosslinking agent may be an amine. In one embodiment, the crosslinking agent may be a diamine, a triamine, or a combination thereof. In another embodiment, the crosslinking agent may be an amide. In a further embodiment, the crosslinking agent may be an acrylate. For instance, the acrylate may be an ethoxylated acrylate, such as an ethoxylated trimethylolpropane triacrylate. Without intending to be limited by theory, it is believed that crosslinking can be employed to improve the integrity of the coating.

In general, an initiator (e.g., benzoyl peroxide) can be used to form a free radical which can attack a double bond on a crosslinking agent, monomer or oligomer to form free radicals which can then subsequently attack other monomers or oligomers and form a three dimensional crosslinked network.

In one embodiment, the binder may also contain an epoxy resin. In general, such an epoxy resin can be formed using any method generally known in the art. The epoxy resins can be synthesized from any compounds that contain an epoxy component. Such compounds may include at least one epoxide functional group, such as at least two epoxide functional groups. In general, an epoxy compound is a compound that includes epoxide groups and may be reacted or cross-linked. These compounds containing the epoxide functional groups can be referred to as the polymerizable compounds of the epoxy resins.

Suitable epoxy resins include, but are not limited to, epoxy resins based on bisphenols and polyphenols, such as, bisphenol A, tetramethylbisphenol A, bisphenol F, bisphenol S, tetrakisphenylolethane, resorcinol, 4,4′-biphenyl, dihydroxynaphthylene, and epoxy resins derived from novolacs, such as, phenol:formaldehyde novolac, cresol:formaldehyde novolac, bisphenol A novolac, biphenyl-, toluene-, xylene, or mesitylene-modified phenol:formaldehyde novolac, aminotriazine novolac resins and heterocyclic epoxy resins derived from p-amino phenol and cyanuric acid. Additionally, aliphatic epoxy resins derived from 1,4-butanediol, glycerol, and dicyclopentadiene skeletons, are suitable. Examples of heterocyclic epoxy compounds are diglycidylhydantoin or triglycidyl isocyanurate.

In certain embodiments, the epoxy resins may include a diglycidyl ether. For instance, the epoxy resins may be non-aromatic hydrogenated cyclohexane dimethanol and diglycidyl ethers of hydrogenated Bisphenol A-type epoxide resin (e.g., hydrogenated bisphenol A-epichlorohydrin epoxy resin), cyclohexane dimethanol. Other suitable non-aromatic epoxy resin may include cycloaliphatic epoxy resins.

Additionally, the epoxy compound may be a combination of an epoxy compound and an acrylate compound. For instance, such compound may be an epoxy acrylate oligomer, such as an epoxy diacrylate, an epoxy tetraacrylate, or a combination thereof. For example, such compound may be a bisphenol A epoxy diacrylate, bisphenol A epoxy tetraacrylate, or a combination thereof. Such acrylate may be any of those referenced herein. For instance, the compound may be a bisphenol A epoxy dimethacrylate or a bisphenol A epoxy tetramethacrylate. Such oligomers may also be modified to include a substituent group. For instance, such substituent group may include an amine, a carboxyl group (e.g., a fatty acid), etc.

In addition, the epoxy groups of the resins may be crosslinked using any method and using any crosslinking agent generally employed in the art. The crosslinking agent may be an amine, an amide, an acid, a phenol, an alcohol, etc. In one embodiment, the crosslinking agent may be an amine. In one embodiment, the crosslinking agent may be a diamine, a triamine, or a combination thereof. In another embodiment, the crosslinking agent may be an amide. In one embodiment, the crosslinking agent may be an acrylate, such as a diacrylate or a triacrylate. In general, an initiator (e.g., benzoyl peroxide) can be used to form a free radical which can attack a double bond on a crosslinking agent or oligomer to form monomeric free radicals which can then subsequently attack other oligomers and form a three dimensional crosslinked network.

The binder may also contain a silicon-containing resin. For instance, the silicon-containing resin may be a polysiloxane resin. In particular, the polysiloxane resin may be a polysilsesquioxane resin. In general, such a silicon-containing resin can be formed using any method generally known in the art. For instance, the silicon-containing resin can be formed by reacting organosilicon compounds, such as organosilane compounds. That is, the organosilicon compounds, such as the organosilane compounds, can be referred to as the polymerizable compounds of the silicon-containing resin.

These organosilicon compounds may include organosilane compounds, such as alkylsilanes including substituted alkyl silanes. The organosilicon compounds may also include organoalkoxysilanes, organofluorosilanes, etc. In this regard, the organosilicon compounds may include a combination of alkylsilane compounds and organoalkoxysilane compounds.

Examples of organoalkoxysilane compounds include those as the aforementioned organoalkoxysilane compound employed in the binder using the sol-gel process. In one embodiment, the silicon-containing resin is made from organosilicon compounds consisting of the organoalkoxysilane compounds as mentioned above.

In general, the crosslinked resins form crosslinks with itself. That is, for example, the first crosslinked resin is formed by reacting a polyol with a crosslinking agent. The second crosslinked resin is formed by reacting silicone-containing compounds. However, in one embodiment, one resin may form covalent bonds with another resin. For instance, the first crosslinked polyol resin may also have some covalent bonds with another resin, such as the silicon-containing resin. In addition, silica particles, such as silica nanoparticles, when employed, can also be used to react with the polyol resin to introduce nanoparticles into the crosslinked polyol resin.

ii. Metal Oxide Particles

As indicated herein, the coating may include at least one metal oxide, which may be included in the coating as a particle or a nanoparticle. For instance, the metal oxide may be a metalloid containing particle or nanoparticle, a metal containing particle nanoparticle, or a combination thereof. These particles include, but are not limited to, SiO₂, TiO₂, ZrO₂, Al₂O₃, ZnO, CdO, SrO, PbO, Bi₂O₃, CuO, Ag₂O, CeO₂, AuO, SnO₂, etc. In one embodiment, any metal oxide particles included in the coating may be in the form of nanoparticles.

In one embodiment, the metal oxide contains at least zinc oxide. Without intending to be limited by theory, the present inventors have discovered that the zinc can provide the coating with beneficial antimicrobial properties. Particularly, the antimicrobial properties of zinc oxide may be attributed to having zinc at or near the surface of the coating. Without intending to be bound by the theory, zinc and reactive oxygen species may be released to react via an electrostatic interaction with microorganisms at the coating surface. In addition, the source of the zinc oxide is not limited by the present invention. For instance, in one embodiment, the source of the zinc oxide may be a glass frit as defined herein. Alternatively, the zinc oxide may be added to the coating. In another embodiment, the zinc oxide may be synthesized via another zinc compound (e.g., zinc acetate) wherein such zinc compound is converted in situ to zinc oxide.

The metal oxide may also include titanium dioxide. Such titanium dioxide may also be present as a nanoparticle. Without intending to be limited by theory, it is believed that the titanium dioxide can be employed to serve as a self-cleaning additive. That is, the titanium dioxide can be employed for cleaning and/or disinfecting surfaces exposed to light. For instance, the photocatalytic activity of the titania at a free surface or near-surface region of the coating attributes to the self-cleaning action. Titania is photocatalytically active with ultraviolet radiation and can be used to decompose organic materials from the surface of a coating.

The metal oxides may also include aluminum oxide and/or zirconium dioxide. Such oxides may also be present in the form of nanoparticles. Without intending to be limited by theory, the aluminum oxide and zirconium dioxide may assist in improving the durability of the glass.

In one embodiment, the metal oxide contains a silica nanoparticle. Without intending to be limited by theory, the present inventors have discovered that the mechanical strength of the polymer network can be further enhanced by employing such silica nanoparticles and that silica nanoparticle may improve optical qualities of the coating. For instance, the silica particle may contain hydroxyl groups that can be condensed with the hydroxyl groups of a silane hydroxyl group of a silanol (e.g., from a hydrolyzed organoalkoxysilane used to form the silicon-containing resin). In addition, the silica particles may also react with a carbocation in the polyol resins via a condensation reaction. In this regard, the silicon-containing nanoparticles may be discrete particles within the coating or may be bonded to a resin.

Regardless of the particles or nanoparticles used, the particles or nanoparticles may be provided in various forms, shapes, and sizes. The average size of the particles and nanoparticles, such as the titanium dioxide or zinc oxide nanoparticles, may generally be about 100 microns or less, such as about 50 microns or less, such as about 10 microns or less, such as about 1 micron or less, such as about 500 nanometers or less, such as about 400 nanometers or less, such as about 300 nanometers or less, such as about 200 nanometers or less, such as about 100 nanometers or less to about 1 nanometer or more, such as about 2 nanometers or more, such as about 5 nanometers or more. As used herein, the average size of a nanoparticle refers to its average length, width, height, and/or diameter.

In addition, the particles and/or nanoparticles may have a specific surface area is greater than 150 m²/g, in some embodiments greater than 200 m²/g.

iii. Glass Frit

As indicated herein, the coating may also include a glass frit. For instance, the glass frit may help adhere the polymers to the glass substrate. The glass frit may have a melting temperature of from about 400° C. to about 700° C., and in some embodiments, from about 500° C. to about 600° C. Alternatively, glass frit according to the present disclosure may have a fairly low melting point. The present inventors have unexpectedly found that by using a glass frit with a low melting point, a tough surface with a rough surface morphology can be formed.

The glass frit typically contains SiO₂ in an amount of from about 25 mol. % to about 55 mol. %, in some embodiments from about 30 mol. % to about 50 mol. %, and in some embodiments, from about 35 mol. % to about 45 mol. %. Other oxides may also be employed. For example, alkali metal oxides (e.g., Na₂O or K₂O) may constitute from about 5 mol. % to about 35 mol. %, in some embodiments from about 10 mol. % to about 30 mol. %, and in some embodiments, from about 15 mol. % to about 25 mol. % of the frit. Al₂O₃ may also be employed in an amount from about 1 mol. % to about 15 mol. %, in some embodiments from about 2 mol. % to about 12 mol. %, and in some embodiments, from about 5 mol. % to about 10 mol. % of the frit.

In other embodiments, the glass frit may also contain a transition metal oxide (e.g., ZnO) as a melting point suppressant, such as in an amount from about 5 mol. % to about 40 mol. %, in some embodiments from about 10 mol. % to about 35 mol. %, and in some embodiments, from about 15 mol. % to about 30 mol. % of the frit. Such metal oxide may be present in the glass frit in an amount of 5 wt. % or more, such as 10% wt. % or more, such as 15 wt. % or more, such as 20 wt. % or more, such as 25 wt. % or more to 50 wt. % or less, such as 45 wt. % or less, such as 40 wt. % or less, such as 35 wt. % or less, such as 30 wt. % or less.

As indicated in section B(ii) above, the coating contains at least one metal oxide. Such metal oxide may be a metal oxide present in the glass frit.

The glass frit may also include oxides that help impart the desired color and to provide a colored glass frit. For example, titanium dioxide (TiO₂) may be employed to help provide a white color, such as in an amount of from about 0.1 mol. % to about 10 mol. %, in some embodiments from about 0.5 mol. % to about 8 mol. %, and in some embodiments, from about 1 mol. % to about 5 mol. % of the frit. Likewise, bismuth oxide (Bi₂O₃) may be employed in certain embodiments to help provide a black color. When employed, Bi₂O₃ may constitute from about 10 mol. % to about 50 mol. %, in some embodiments from about 25 mol. % to about 45 mol. %, and in some embodiments, from about 30 mol. % to about 40 mol. % of the frit.

The glass frit is typically present in the coating in an amount of about 40 wt. % or more, such as about 50 wt. % or more, such as about 60 wt. % or more, such as about 70 wt. % or more to about 99 wt. % or less, such as about 95 wt. % or less, such as about 90 wt. % or less, such as about 85 wt. % or less, such as about 80 wt. % or less, such as about 70 wt. % or less. Such concentration may be for a coating after curing and/or after tempering.

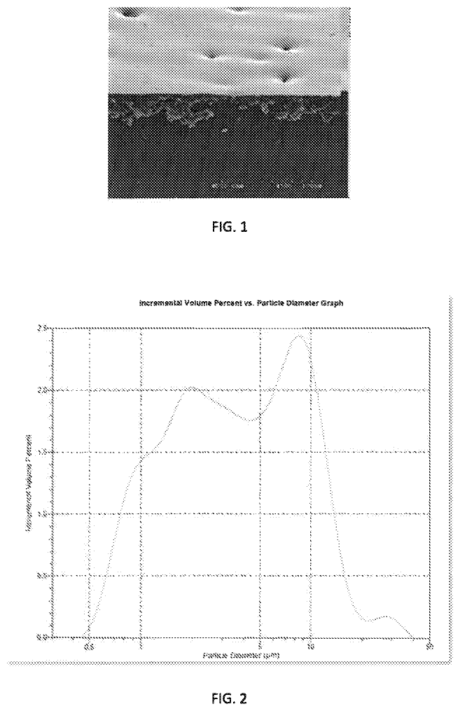

Regardless of the chosen composition of the glass frit, the glass frit may include particles having a narrow particle diameter distribution. As generally shown in FIG. 2, an example according to the present disclosure may generally have a particle diameter between about 0.1 μm and about 50 μm. However, glass frit according to the present disclosure may have a particle diameter outside of the range disclosed in the example of FIG. 2, such as greater than about 1 μm, such as greater than about 5 μm, such as greater than about 10 μm, such as greater than about 15 μm, such as greater than about 20 μm, such as greater than about 25 μm, such as greater than about 30 μm, such as greater than about 35 μm, such as greater than about 40 μm, such as greater than about 45 μm, such as greater than about 50 μm, such as greater than about 55 μm, such as greater than about 60 μm, such as greater than about 70 μm, such as less than about 100 μm, such as less than about 95 μm, such as less than about 90 μm, such as less than about 85 μm, such as less than about 80 μm, such as less than about 75 μm, such as less than about 70 μm, such as less than about 65 μm.

The glass frit may have a D50 of 2 μm or more, such as 2.5 μm or more, such as 3 μm or more, such as 3.5 μm or more, such as 4 μm or more to 7 μm or less, such as 6.5 μm or less, such as 6 μm or less, such as 5.5 μm or less, such as 5 μm or less, such as 4.5 μm or less, such as 4 μm or less. The glass frit may have a D10 of 0.25 μm or more, such as 0.5 μm or more, such as 0.75 μm or more, such as 1 μm or more to 2.5 μm or less, such as 2 μm or less, such as 1.5 μm or less, such as 1.25 μm or less. The glass frit may have a D90 of 6 μm or more, such as 6.5 μm or more, such as 7 μm or more, such as 7.5 μm or more, such as 8 μm or more, such as 8.5 μm or more, such as 9 μm or more, such as 9.5 μm or more, such as 10 μm or more, such as 10.5 μm or more, such as 11 μm or more to 20 μm or less, such as 15 μm or less, such as 14 μm or less, such as 13 μm or less, such as 12.5 μm or less, such as 12 μm or less, such as 11.5 μm or less.

In addition, the glass frit employed may have a glass transition temperature of 300° C. or more, such as 350° C. or more, such as 400° C. or more, such as 425° C. or more, such as 450° C. or more, such as 475° C. or more, such as 500° C. or more, such as 525° C. or more, such as 550° C. or more. The glass transition temperature may be 800° C. or less, such as 750° C. or less, such as 700° C. or less, such as 650° C. or less, such as 600° C. or less, such as 575° C. or less.

iv. Additional Additives

The coating may also include any number of additives as generally known in the art. In general, these additives may be added to the coating formulation containing the polymerizable compounds. In this regard, the additives may be present during polymerization and/or crosslinking of the polymerizable compounds and resin. In some instances, the additives may form covalent bonds with the polymerizable compounds and/or a resin.

As indicated herein, the coating may include at least one colorant. For instance, the colorant may include a pigment, a dye, or a combination thereof. For instance, the colorant may be an inorganic pigment (e.g., metallic pigments, white pigments, black pigments, green pigments, red/orange/yellow pigments, etc.), a fluorescent colorant, or a combination thereof. The colorant may be employed to provide a certain color the glass substrate and/or coating.

As indicated herein, the coating may include at least one light stabilizer. For instance, the light stabilizer may comprise a UV absorber (e.g., benzophenones, benzotriazoles, triazines, and combinations thereof), a hindered amine, or a combination thereof. In general, UV absorbers may be employed in the coating to absorb ultraviolet light energy. Meanwhile, hindered amine light stabilizers may be employed in the coating to inhibit degradation of the resins and coating thereby providing color stability and extending its durability. As a result, in some embodiments, a combination of a UV absorber and a hindered amine light stabilizer may be employed.

As indicated herein, the coating may contain at least one hindered amine light stabilizer (“HALS”). Suitable HALS compounds may be piperidine-based compounds. Regardless of the compound from which it is derived, the hindered amine may be an oligomeric or polymeric compound. The compound may have a number average molecular weight of about 1,000 or more, in some embodiments from about 1,000 to about 20,000, in some embodiments from about 1,500 to about 15,000, and in some embodiments, from about 2,000 to about 5,000. In addition to the high molecular weight hindered amines, low molecular weight hindered amines may also be employed. Such hindered amines are generally monomeric in nature and have a molecular weight of about 1,000 or less, in some embodiments from about 155 to about 800, and in some embodiments, from about 300 to about 800.

In addition, the light stabilizer may be a polymerizable light stabilizer. In this regard, the polymerizable light stabilizer can be directly attached to a resin, such as a resin in the binder. Such attachment can provide a benefit of minimizing or removing the mobility of the light stabilizer. Such light stabilizers can simply be reacted via a functional group with a functional group of a resin during curing. These polymerizable light stabilizers may contain a carbon-carbon double bond, a hydroxyl group, a carboxyl group, an active ester group, and/or an amine group that allows for the light stabilizer to be covalently attached with the resins. In essence, the light stabilizer would be a part of the backbone of the resin either in an intermediate part of the resin or a terminal part of the resin. Suitably, the light stabilizer is present in an intermediate part of the resin.

The coating formulation may contain a surfactant. The surfactant may be an anionic surfactant, a cationic surfactant, and/or a non-ionic surfactant. For instance, in one embodiment, the surfactant may be a non-ionic surfactant. The non-ionic surfactant may be an ethoxylated surfactant, a propoxylated surfactant, an ethoxylated/propoxylated surfactant, polyethylene oxide, an oleate (e.g., sorbitan monooleate, etc.), fatty acid ester or derivative thereof, an alkyl glucoside, a sorbitan alkanoate or a derivative thereof, a combination thereof, etc. When employed, surfactants typically constitute from about 0.001 wt. % to about 2 wt. %, in some embodiments from about 0.005 wt. % to about 1 wt. %, in some embodiments, from about 0.01 wt. % to about 0.5 wt. % of the formulation, and in some embodiments from about 0.1 wt. % to about 0.25 wt. %.

The coating formulation may also contain one or more organic solvents. Any solvent capable of dispersing or dissolving the components may be suitable, such as alcohols (e.g., ethanol or methanol); dimethylformamide, dimethyl sulfoxide, hydrocarbons (e.g., pentane, butane, heptane, hexane, toluene and xylene), ethers (e.g., diethyl ether and tetrahydrofuran), ketones and aldehydes (e.g., acetone and methyl ethyl ketone), acids (e.g., acetic acid and formic acid), and halogenated solvents (e.g., dichloromethane and carbon tetrachloride), and so forth. The coating formulation may also contain water. Although the actual concentration of solvents employed will generally depend on the components of the formulation and the substrate on which it is applied, they are nonetheless typically present in an amount from about 1 wt. % to about 40 wt. %, in some embodiments from about 5 wt. % to about 35 wt. %, and in some embodiments, from about 10 wt. % to about 30 wt. % of the formulation (prior to drying).

In addition, other additives may be employed to facilitate dispersion of the components and/or assist in formation of the coating. For instance, the coating formulation may contain an initiator and/or a catalyst, such as an acid catalyst. Examples of such acid catalysts may include, for instance, acetic acid, sulfonic acid, nitric acid, hydrochloric acid, malonic acid, glutaric acid, phosphoric acid, etc., as well as combinations thereof. Also, the initiator may be a photoinitiator that allows for the polymerization of a polymerizable compound, such as an acrylate.

C. Process

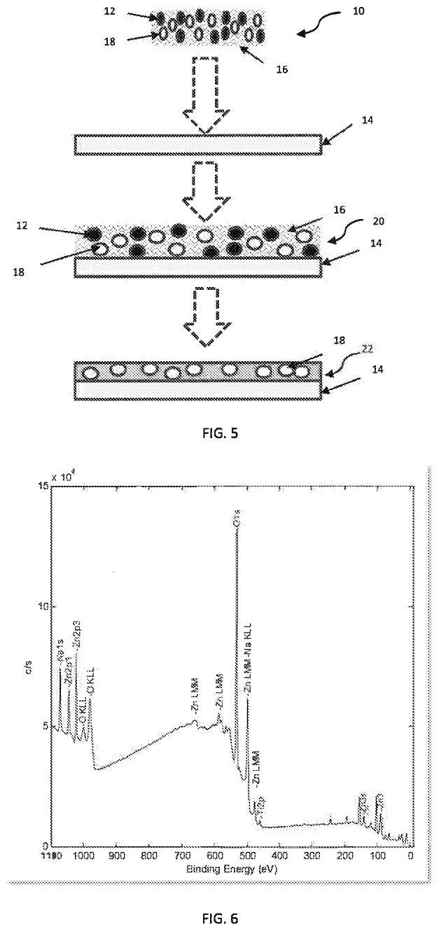

A variety of different techniques may generally be employed to form the coating and in particular the binder as generally shown in FIG. 5. As just one example, in FIG. 5, a coating formulation 10 comprising a glass frit 12 is applied to a surface of the glass substrate 14. The coating formulation also contains the binder which includes polymerizable compounds 16 (e.g., monomers, oligomers and/or pre-polymers). The coating formulation may also contain metal oxides 18.

Once applied to the substrate, the coating formulation can be heated to form the coating layer 20 and then cured to form the coating layer 22. During or before the heating step, techniques may be employed to polymerize the polymerizable compounds. Such techniques may include exposure to UV radiation. In this regard, the combination of UV radiation and heating can allow for the formation of an interpenetrating network. Alternatively, if employing the aforementioned alkoxides, the heating may allow for hydrolysis and condensation of the polymer network containing the silicon alkoxides (e.g., tetraethyl orthosilicate) and any other alkoxides.

Suitable application techniques for applying the coating formulation to the glass substrate may involve, for example, dip coating, drop coating, bar coating, slot-die coating, curtain coating, roll coating, spray coating, printing, etc. The kinematic viscosity of the formulation may be adjusted based on the particular application employed. Typically, however, the kinematic viscosity of the formulation is about 450 centistokes or less, in some embodiments from about 50 to about 400 centistokes, and in some embodiments, from about 100 to about 300 centistokes, as determined with a Zahn cup (#3), wherein the kinematic viscosity is equal to 11.7(t−7.5), where t is the efflux time (in seconds) measured during the test. If desired, viscosity modifiers (e.g., xylene) can be added to the formulation to achieve the desired viscosity.

Once applied, the coating formulation may be polymerized to form the interpenetrating network. The method of polymerization can be any as generally known in the art. For instance, polymerization may be via UV radiation, heating or a combination thereof. In one embodiment, only heating may be employed. In one embodiment, both UV radiation and heating may be employed to polymerize the various compounds. For instance, UV radiation may be employed to polymerize any acrylate compounds. Meanwhile, heating may be employed to form the crosslinked polyol and polysiloxane. Such heating and UV exposure may be simultaneous. Alternatively, the heating may be conducted first and the UV light may follow. Or, the UV exposure may be first and the heating may follow.

The coating formulation may be heated to polymerize and cure the polymerizable compounds. For example, the coating formulation may be cured at a temperature of from about 50° C. to about 350° C., in some embodiments from about 75° C. to about 325° C., in some embodiments from about 100° C. to about 300° C., in some embodiments from about 150° C. to about 300° C., and in some embodiments, from about 200° C. to about 300° C. for a period of time ranging from about 30 seconds to about 100 minutes, in some embodiments from about 30 seconds to about 50 minutes, in some embodiments from about 1 to about 40 minutes, and in some embodiments, from about 2 to about 15 minutes. Curing may occur in one or multiple steps. If desired, the coating formulation may also be optionally dried prior to curing to remove the solvent from the formulation. Such a pre-drying step may, for instance, occur at a temperature of from about 20° C. to about 150° C., in some embodiments from about 30° C. to about 125° C., and in some embodiments, from about 40° C. to about 100° C.

In addition to heating, as indicated above, other techniques may also be utilized to polymerize the compounds. For instance, with the presence of initiators, a UV light may be employed to polymerize the compounds.

The UV exposure may conducted at an intensity and time period that allows for sufficient polymerization depending on the types of monomers. For instance, for certain acrylates, UV exposure at an intensity of about 15 mW/cm² or more, such as about 20 mW/cm² or more, such as about 25 mW/cm² or more, such as about 30 mW/cm² or more for a period of time ranging from about 30 seconds to about 100 minutes, in some embodiments from about 30 seconds to about 50 minutes, in some embodiments from about 1 to about 25 minutes, and in some embodiments, from about 1 to about 10 minutes should be sufficient. In one embodiment, the UV exposure may be from 25 to 30 mW/cm² for a period of 5 minutes. In addition, UV exposure may be conducted in an inert atmosphere. For instance, the exposure may be conducted in the presence of argon gas or nitrogen gas. In one particular embodiment, the UV exposure is conducted in the presence of nitrogen gas.

If desired, the glass article may also be subjected to an additional heat treatment (e.g., tempering, heat bending, etc.) to further improve the properties of the article. The heat treatment (or tempering) may, for instance, occur at a temperature of from about 500° C. to about 800° C., and in some embodiments, from about 550° C. to about 750° C. The glass article may also undergo a high-pressure cooling procedure called “quenching.” During this process, high-pressure air blasts the surface of the glass article from an array of nozzles in varying positions. Quenching cools the outer surfaces of the glass much more quickly than the center. As the center of the glass cools, it tries to pull back from the outer surfaces. As a result, the center remains in tension, and the outer surfaces go into compression, which gives tempered glass its strength.

The cured and/or tempered coating may have a thickness of about 1 micron or more, such as about 5 microns or more, such as about 10 microns or more, such as about 15 microns or more to about 250 microns or less, such as about 150 microns or less, such as about 100 microns or less, such as about 75 microns or less, such as about 60 microns or less, such as about 50 microns or less. The present inventors have discovered that they can provide thinner coatings with the present binder and comparable or even better properties in comparison to coatings containing only one or two binders. However, it should be understood that the thickness of the coating is not necessarily limited by the present invention.

In addition, in one embodiment, the glass may be rendered translucent due to the coating. For example, a coated glass substrate according to the present disclosure may have a percent transparency of less than about 90%, such as less than about 85%, such as less than about 80%, such as less than about 75%, such as less than about 70%, such as less than about 65%, such as less than about 60% and greater than about 30%, such as greater than about 40%, such as greater than about 50%. Additionally, a coated glass substrate according to the present disclosure may have a percent haze of at least about 50%, such as at least about 60%, such as at least about 70%, such as at least about 75%, such as at least about 80%, such as at least about 85%, such as at least about 90%, such as at least about 95%, such as at least about 99%, such as at least about 100%. Furthermore, a coated glass substrate according to the present disclosure may have a percent clarity of less than about 30%, such as less than about 25%, such as less than about 20%, such as less than about 17.5%, such as less than about 15%, such as less than about 12.5%, such as less than about 10%, such as less than about 7.5%, such as less than about 5%, such as less than about 2.5%. In this regard, the coated glass substrate may be a translucent coated substrate.

After conducting CASS testing, such coated glass substrate may have a minimal change in the aforementioned transparency and/or haze parameters. For instance, such change may be within 10%, such as within 7%, such as within 5%, such as within 4%, such as within 3%, such as within 2%, such as within 1%. Such parameters may be within the aforementioned percentages even after a condenser chamber test.

Furthermore, the gloss of the coated glass substrate may be variable depending on the degree of measurement. For instance, at 20°, the gloss may be 0.1 or more, such as 0.2 or more, such as 0.5 or more, such as 1 or more, such as 2 or more, such as 5 or more, such as 10 or more to 30 or less, such as 20 or less, such as 15 or less, such as 10 or less, such as 7 or less, such as 5 or less, such as 4 or less, such as 3 or less. Meanwhile, at 60°, the gloss may be 1 or more, such as 2 or more, such as 3 or more, such as 5 or more, such as 8 or more, such as 10 or more, such as 15 or more to 40 or less, such as 30 or less, such as 25 or less, such as 20 or less, such as 15 or less, such as 12 or less, such as 7 or less. The gloss may be determined using any gloss meter as generally known in the art.

After conducting CASS testing, such coated glass substrate may have a minimal change in the aforementioned gloss parameters. For instance, such change may be within 10%, such as within 7%, such as within 5%, such as within 4%, such as within 3%, such as within 2%, such as within 1%, such as within 0.5%, such as within 0.1%. Such parameters may be within the aforementioned percentages even after a condenser chamber test.

However, it should be understood that the coated glass substrate may also be a transparent coated glass substrate. For instance, the coated substrate according to the present disclosure may have a percent transparency of greater than about 80%, such as about 85% or more, such as about 90% or more, such as about 93% or more, such as about 95% or more, such as about 97% or more, such as about 98% or more. Additionally, a coated glass substrate according to the present disclosure may have a percent haze of about 50% or less, such as about 40% or less, such as about 30% or less, such as about 20% or less, such as about 10% or less, such as about 5% or less. Furthermore, a coated glass substrate according to the present disclosure may have a percent clarity of greater than about 20%, such as greater than about 40%, such as greater than about 50%, such as greater than about 75%, such as greater than about 90%. Such values may be within 10%, such as within 8%, such as within 5%, such as within 3%, such as within 2%, such as within 1% of the uncoated, raw glass.

Furthermore, the gloss of the coated glass substrate may be variable depending on the degree of measurement. For instance, at 20°, the gloss may be 0.1 or more, such as 1 or more, such as 10 or more, such as 25 or more, such as 50 or more, such as 75 or more, such as 100 or more, such as 125 or more, such as 140 or more to 200 or less, such as 180 or less, such as 160 or less, such as 150 or less. The gloss at 60° may fall within the same ranges. The gloss may be determined using any gloss meter as generally known in the art.

In addition to the above, the coated glass substrate may have a certain refractive index, in particular at 550 nm. For instance, the refractive index may be 1.2 or more, such as 1.25 or more, such as 1.3 or more to 1.7 or less, such as 1.6 or less, such as 1.5 or less, such as 1.45 or less, such as 1.4 or less, such as 1.38 or less, such as 1.35 or less.

While embodiments of the present disclosure have been generally discussed, the present disclosure may be further understood by the following, non-limiting examples.

### EXAMPLES

### Test Methods

Coating Thickness: The coated layer of as coated glass is removed by a razor. The step height of the coating is observed using a profilometer. The data is an average measured from three points at different positions.

Atomic Force Microscopy: The topography is investigated by an atomic force microscope (AFM, AP-0100, Parker Sci. Instrument). The non-contact method, preferred for soft surface in general is used. The size of the sample is about 2 cm by 2 cm and the scanning area is 5,000 microns by 5,000 microns. The scanning speed of 20 microns/second. The surface roughness is quantitatively characterized by measuring the arithmetic average roughness and root mean square roughness.

Cross-Hatch Adhesion: The cross-hatch adhesion is determined in accordance with ASTM D3359-09. For the test, cuts a certain distance apart are made in the coating depending on the thickness of the coating. Additionally, intersecting cuts are also made. Tape is placed on the grid area and within approximately 90 seconds of application, the tape is removed by pulling it off rapidly at as close to an angle of 180° as possible. The grid area is inspected for removal of coating from the substrate. The classifications go from OB to 5B wherein 5B indicates that none of the squares of the lattice are detached. A value of less than 3B is indicative of a failure.

XPS Measurements: XPS data was acquired with a PHI Quantum 2000 unit using a probe beam of focused, monochromatic Al Kα radiation (1486.6 eV). The analysis area was 600 microns and the take-off angle and the acceptance angle were about 45° and +/−23°, respectively. The sputter rate was ˜100 Angstroms/minute (SiO₂ equivalent) and ion gun condition was Ar+ (2 keV, 2 mm by 2 mm raster). The atomic composition and chemistry of the sample surface is determined. The escape depth of the photoelectrons limits the depth of the analysis to the outer ˜50 Angstroms. The typical detection limits for most other elements is 0.1 to 1 atomic %. The data presented includes general survey scans, which give the full spectrum between 0 and 1100 eV binding energy.

Scanning Electron Microscopy (SEM): The morphologies of the antiscratch glass were observed by Hitachi S4800 field emission SEM. The working distance was 4.0 mm and 6.7 mm for images of a top surface and a rotated position (45 degrees), respectively. A tungsten coated layer with a thickness of 5 to 10 nm was on the surface and the accelerating voltage was 5 kV.

Stud Pull Strength: The adhesive strength of the coating can be evaluated by measuring the stud pull strength. The coating surface is blown with nitrogen gas. An aluminum dolly with a diameter of 20 mm is polished by sand paper (100#). An aldehyde-amine condensate/organocopper compound mixture (Loctite 736) is sprayed on the surface of the coating and an aluminum stud. After 5 minutes, an acrylic adhesive (312) s added to the surface of the aluminum stud and it is glued to the surface of the coating with pressure until solid adhesion is achieved. The glued aluminum stud and glass are placed at room temperature for 3 hours. The dolly is pulled by a PosiTest AT with a pull rate of 30 psi/sec. The adhesive strength is measured by the PosiTest AT. A strength of less than 450 psi is considered a failure.

Transparency: Transparency (T %) was measured by Hunter UltraScan XE with model of TTRIN from 350 nm to 1050 nm. Tvis % is calculated according to the following equation.

$$Tvis \% = \frac{{\sum }_{i = 380}^{780} {( T \% )}_{i}}{{\sum }_{i = 380}^{780} {N}_{i}}$$

Tuv % of antimicrobial glass at UV range is measured by UV-vis (Peking Elmer 950) and Tuv % is calculated by following equation.

$$Tuv \% = \frac{{\sum }_{i = 300}^{380} {( T \% )}_{i}}{{\sum }_{i = 300}^{380} {N}_{i}}$$

Water Boil Test: The water boil test follows the testing procedure of TP319 (Guardian Ind.). Glass is immersed in one beaker filled with De-ion water at 100° C. After 10 min, the glass is removed from boiling water and dried by N2 gas before measurement. The change of T % will be calculated by the difference of T % before and after water boil test. The specification of water boil test is ΔT %<±0.5%.

NaOH Solution (0.1N) Test: NaOH test follows the testing procedure of TP301-7B (Guardian Ind.). Glass is immersed by NaOH solution (0.1 N) filled in one beaker at room temperature. After 1 hour, the glass is taken from solution, rinsed by De-ion water and dried by N2 gas. The change of T % will be calculated by the difference of T % before and after NaOH testing. The specification of water boil test is ΔT %<±0.5%.

Tape Pull Test: Tape pull test follows the testing procedure of TP-201-7 (Guardian Ind.). The tape (3179C, 3M) is placed on the surface of the glass by applying pressure. After 1.5 minutes, the tape is pulled out quickly with hand and the residual adhesive of tape will be removed with tissue paper (Accu Wipe) soaked by NPA. The change of T % will be calculated by the difference of T % before and after tape pull test. The specification of tape pull test is ΔT %<1.5%.

Crockmeter Test: Crockmeter test follows the testing procedure of TP-209 (Guardian Ind.; Crockmeter: SDL Atlas CM-5). The size of glass is 3″×3″ and total test cycle number is 750. The weight of arm is 345 g. The change of T % will be calculated by the difference of T % before and after crockmeter test. The specification of crockmeter test is ΔT %<1.5%.

Brush Test: G with size of 2″×3″ is mounted on chamber filled with DI water and brush with size of 2″×4″ is used to scratch the surface of as coated glass. The cycle number of brush including back and forth motion is 1000. The surface of “as coated” glass is exanimated by microscopy after testing and no clear scratch on film will be the sign of passing test. The change of T % will be calculated by the difference of T % before and after brush test.

Taber Abrasion Test: Glass with size as 4″×4″ is amounted on sample holder of Taber (Model 5130 Abraser). Abrasion wheel is CS-10F and cycle number is 5. The change of T % will be calculated by the difference of T % before and after abrasion test.

High Humidity and High Temperature Chamber Test: Glass is set inside chamber with 85° C. and 85% of humidity for 10 days. The change of T % will be calculated by the difference of T % before and after testing.

Ammonium Solution Test: 10% of NH₄OH solution is prepared by diluting of 29% of NH₄OH solution with DI water. Antimicrobial glass is soaked inside solution and T % is measured before and after soaking of 5 days. The change of T % will be calculated by the difference of T % before and after testing.

Windex Test: Glass is soaked inside 100% of Windex solution and T % is measured before and after soaking of 5 days. The change of T % will be calculated by the difference of T % before and after testing.

Condense Chamber Test (Water Fog): Glass is set in chamber with 45° C. and 100% of humidity for 21 days. T % before and after testing is measured. Meanwhile, adhesive strength of coated layer after testing is investigated by cross-hatch and no more 15% of film can be removed in order to pass test. The change of T % will be calculated by the difference of T % before and after testing.

Copper Accelerated Acetic Acid Salt Spray (CASS) Test: Glass is set in CASS chamber for 120 hours (5 days). The solution used in CASS test is made by 0.94 g of CuCl₂, 4.6 g of acetic acid and 258 g of NaCl. The chamber temperature is 49° C. and pressure is 18 psi, respectively. The pH of solution is in the range from 3.1 to 3.3. The specification of CASS chamber test is ΔT %<1.5%. The change of T % will be calculated by the difference of T % before and after testing.

Freeze Thaw Chamber Test: Glass with size as 3″×3″ is set freeze thaw chamber for 10 days. Humidity is in the range from 50-85% and temperature range is from −40° C. to 85° C. The change of T % will be calculated by the difference of T % before and after testing.

### Materials

In the following examples, the following materials were utilized.

The glass frits utilized in the samples had the following compositions:

| Elements (wt. %) | GAL 56336 | GAL 56337 |
|---|---|---|
| F | 1 | 2 |
| Na₂O | 22.6 | 21.4 |
| Al₂O₃ | 0.9 | 7.8 |
| SiO₂ | 41.6 | 39.8 |
| TiO₂ | 5.8 | 3.8 |
| ZnO | 27.9 | 25.8 |

The polystyrene-co-methyl methacrylate copolymer binder included the following:

| Chem. | Amt. |
|---|---|
| Polystyrene-co-methyl methacrylate copolymer | 15 |
| (PSMMA, Mn: 100,000-150,000) (g) | |
| Xylene/Butanol (1:1; wt. ratio) (mL) | 85 |

The monomer formulation (429-98-1) included the following:

| Chem. | wt., g/ml |
|---|---|
| Blocked polyisocyanate (g) | 10 |
| Epoxy acrylate oligomer (g) | 40 |
| Polyether polyol (g) | 5 |
| Ethoxylated trimethylolpropane triacrylate (g) | 8 |
| Xylene (mL) | 20 |
| Butanol (mL) | 20 |

The entire binder including the PSMMA binder and monomer formulation 429-98-1 contains three parts including a polyisocyanate-polyol resin, an epoxy acrylate, and polystyrene-co-methyl methacrylate. To a 200 mL glass jar, 10 grams of blocked polyisocyanate, 40 grams of epoxy oligomer, 8 grams of crosslinking agent, and 5 grams of polyol were added. Then 20 mL of xylene and butanol were added separately. The solution was mixed by a stir bar for 1 hour at room temperature and mixed with 15% of polystyrene-co-methyl methacrylate in mixed solvent of xylene and butanol with the ratio of 5 to 30.

The initiator solution (421-37-1) included the following:

| Chem. | Amt. |
|---|---|
| Benzoyl peroxide (g) | 0.25 |
| Xylene (mL) | 10 |

The AgO nanoparticle solution included the following:

| Chem. | Amt. |
|---|---|
| AgO nanoparticle (10 nm) (g) | 0.1 |
| Xylene (mL) | 9.9 |

The coating formulation was prepared by adding the glass frit to a 100 mL jar and then the PSMMA binder/429-98-1. Then the initiator solution and any surfactant were added to the jar. The solution was diluted by a mixed solvent of xylene and butanol. The solution was then ground by ball mill and five cubic aluminum type grading media. The ball mill time was at least 3 days.

For the IPN formulations, flat glass plate with a size of 8 inches by 12 inches and a thickness of 4 mm were washed with 1% of cesium oxide solution and rinsed by tap water. Then, the glass was washed by soap and thoroughly rinsed with deionized water. Finally, the glass plate was dried by nitrogen gas. The cleaned glass is placed on a table of a coating machine and a bird bar with different sizes, such as 2, 3, and 4 mil is set in front of the glass. The coating speed was set at 100 mm/sec. The coated glass was transferred to the oven at 380 degrees Celsius for 20 minutes in order to generate “as coated glass.” If desired for the example, the “as coated” glass was heated at 650 degrees Celsius at various times in order to develop tempered glass.

### Example 1

A coating formulation containing a glass frit with zinc oxide and titanium dioxide and polymerizable compounds for the formation of an IPN was applied to one surface of a glass substrate. The coating formulation employed in the samples is summarized in the table below.

| Chem. | 456-79-5 | 456-79-6 |
|---|---|---|
| Glass frit (GAL 56337) (g) | 8 | 8 |
| PSMMA Binder/429-98-1 (30:5 wt. ratio) (g) | 5 | 5 |
| PEG 1900 (ml) | 0.5 | 0.5 |
| Initiator, 421-37-1 (ml) | 0.2 | 0.2 |
| Xylene/butanol (1:1) (ml) | 3 | 3 |
| TiO2, <25 nm (g) | 0.05 | 0 |
| ZnO, 35 nm (g) | 0.5 | 0 |

The coating formulation was applied to a glass substrate and cured at a low temperature. The glass substrate with the coating was then tempered to form a coated glass substrate.

XPS spectra of the glass surface of sample 456-79-5 were obtained as illustrated in FIG. 6 and the following table provides the surface composition.

| Element | B | C | O | Na | Al | Si | Ti | Zn |
|---|---|---|---|---|---|---|---|---|
| Atomic % | 7.3 | 0.2 | 58.8 | 10 | 2.3 | 15.7 | 0.7 | 4.9 |
| Weight % | 3.74 | 0.11 | 44.61 | 10.90 | 2.94 | 20.91 | 1.59 | 15.19 |

The XPS analysis indicates the presence of titanium around 1.59 wt. % and zinc around 15.19 wt. %, after conversion from atomic %, on the surface of coating of the glass.

Additionally, scanning electron microscopy was performed. As indicated in the image of FIG. 1, a rough surface can be observed. Generally, such a surface may improve the active area of self-cleaning and antimicrobial properties.

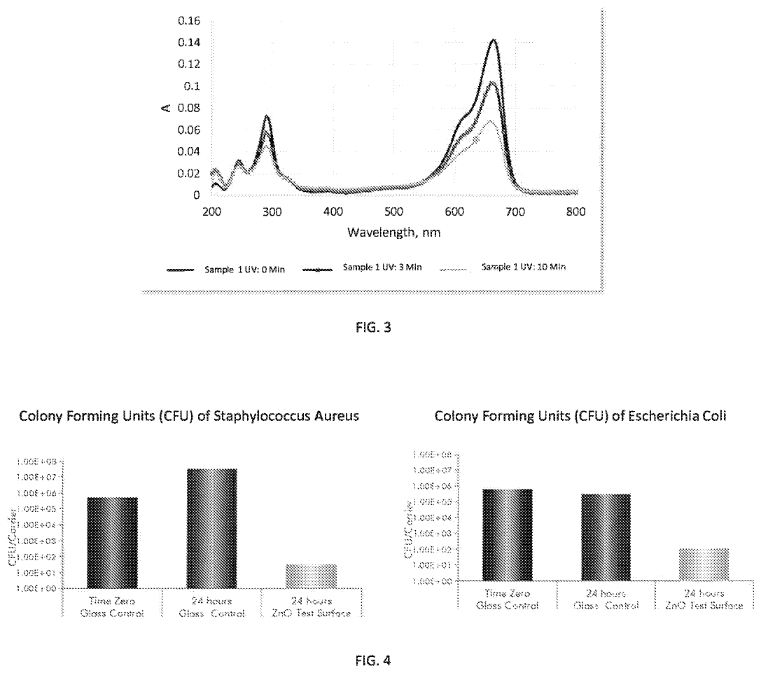

Also, self-cleaning performance was investigated by the degradation of methylene blue in solution, immersing the coated glass substrate in the solution, and irradiating by UV light at a wavelength of 365 nm. The results are illustrated in FIG. 3. In particular, FIG. 3 shows that a coating according to the present disclosure may exhibit about a 54% reduction in the amount of methylene blue when the solution has been irradiated for about 10 minutes.

### Example 2

A coating formulation containing a glass frit with zinc oxide, silver oxide, and polymerizable compounds for the formation of an IPN was applied to one surface of a glass substrate. The coating formulation employed in the samples is summarized in the table below.

| Chem. | 450-128-3 | Control |
|---|---|---|
| Glass frit (GAL 56337) (g) | 17 | 17 |
| AgO solution (mL) | 0.6 | 0 |
| PSMMA Binder/429-98-1 (30:5 wt. ratio) (g) | 10 | 10 |
| PEG 1900 (mL) | 0.5 | 0.5 |
| Initiator, 421-37-1 (mL) | 0.2 | 0.2 |
| Xylene/butanol (1:1) (mL) | 1.4 | 1.4 |

The coating formulation was applied to a glass substrate and cured at a low temperature. The glass substrate with the coating was then tempered to form a coated glass substrate.

XPS spectra of the glass surface sample 450-128-3 were obtained and the following table provides the surface composition.

| Element | B | C | O | Na | Al | Si | Ca | Ti | Zn |
|---|---|---|---|---|---|---|---|---|---|
| Atomic | 7.1 | 2.4 | 58.4 | 7.5 | 3.3 | 14.8 | 0.3 | 1.1 | 5.2 |
| % | | | | | | | | | |
| Weight | 3.62 | 1.36 | 44.04 | 8.13 | 4.20 | 19.59 | 0.57 | 2.48 | 16.03 |
| % | | | | | | | | | |

The XPS analysis indicates the presence of titanium dioxide and zinc oxide around the surface of the coating of the glass. The comparative sample was the same as sample 456-79-5 except without the presence of the AgO solution.

Additionally, surface roughness measurements were obtained. The results are provided in the following table.

| Sample | Sq (μm) | Sa (μm) | Sp (μm) | Sv (μm) |
|---|---|---|---|---|
| Comparative Sample 1 | 0.894 | 0.677 | 7.81 | 6.27 |
| 450-128-3 | 0.895 | 0.687 | 6.32 | 4.22 |

### Example 3

Samples were tested to determine the green strength of as-coated glass as a function of zinc oxide content prior to tempering.

| | 450- | 450- | 450- | 450- |
|---|---|---|---|---|
| ID | 144-1 | 144-2 | 144-3 | 144-4 |
| Glass frit (GAL 56337) (g) | 16.5 | 16 | 15 | 14 |
| ZnO nanoparticle (45 nm) (g) | 0.5 | 1 | 2 | 3 |
| PSMMA Binder/429-98-1 (30:5 wt. ratio) (g) | 10 | 10 | 10 | 10 |
| PEG 1900 (ml) | 0.5 | 0.5 | 0.5 | 0.5 |
| Initiator, 421-37-1 (ml) | 0.2 | 0.2 | 0.2 | 0.2 |
| Xylene/Butanol (1:1 wt. ratio) (mL) | 3 | 3 | 3 | 3 |
| Frit + ZnO nanoparticles (g) | 17 | 17 | 17 | 17 |
| Polymer binder (wt. %) | 32.57 | 32.57 | 32.57 | 32.57 |
| ZnO nanoparticle in coating layer (wt. %) | 2.94 | 5.88 | 11.76 | 17.65 |

The coating formulation was applied to a glass substrate and cured at a low temperature. The samples were tested to assess their optical and mechanical properties.

| | ZnO | Cross- | Stud pull | Transparency | Haze | Clarity |
|---|---|---|---|---|---|---|
| | wt. % | Hatch | (psi) | (%) | (%) | (%) |
| 450-144-1 | 2.94 | 5B | 693 | 78.5 | 82.4 | 16.7 |
| 450-144-2 | 5.88 | 5B | 671 | 73.3 | 91.5 | 13.9 |
| 450-144-3 | 11.76 | 3B | 603 | 66.3 | 99.3 | 6.5 |
| 450-144-4 | 17.65 | 2B | 687 | 56 | 103 | 4.9 |

Antimicrobial performance of sample 450-144-2 (translucent glass) is evaluated by procedure JIS Z2801 using two microorganisms, Staphylococcus aureus (ATCC 6538) and Escherichia coli (ATCC 8739) under testing conditions of 36° C. for 24 hours. The sample and the control were coated by a solution containing the microorganisms and the number of microorganisms was counted before and after testing. The table below, as well as FIG. 4, summarizes the results. In can be seen from the table that the percent reduction for both S. aureus and E. coli is higher than 99.9%, indicating excellent antimicrobial performance.

| Micro- | | Contact | CFU/ | Percentage | Log 10 |
|---|---|---|---|---|---|
| organism | Surface | time, hour | carrier | reduction | reduction |
| S. aureus | Control | 0 | 6.00E+05 | N/A | |
| (ATCC | | 24 | 3.00E+05 | | |
| 6538) | 450-144-2 | 24 | 1.10E+02 | 99.96 | 3.44 |
| E. coli | Control | 0 | 5.00E+05 | N/A | |
| (ATCC | | 24 | 3.22E+07 | | |
| 8739) | 450-144-2 | 24 | 3.00E+01 | 99.99991% | 6.03 |

### Example 4

Coating formulations were prepared according to the following table.

| | 429- | 429- | 429- | 429- | 429- |
|---|---|---|---|---|---|
| | 132-7 | 146-1 | 146-2 | 146-5 | 146-6 |
| Glass frit | 10 | 13 | 17 | — | — |
| (GAL 56337) (g) | | | | | |
| Glass frit | — | — | — | 13 | 17 |
| (GAL 56336) (g) | | | | | |
| PSMMA Binder/429-98-1 | 10 | 10 | 10 | 10 | 10 |
| (30:5 wt. ratio) (g) | | | | | |
| PEG 1900 (mL) | 1 | 1 | 1 | 1 | 1 |
| Initiator, 421-37-1 | 0.2 | 0.2 | 0.2 | 0.2 | 0.2 |
| (ml) | | | | | |
| Xylene/Butanol | 0 | 1 | 2 | 1 | 2 |
| (1:1) (mL) | | | | | |
| Frit % in binder | 47.17 | 51.59 | 56.29 | 51.59 | 56.29 |

Surface roughness measurements were obtained. The results are provided in the following table. The results also include the surface roughness as a function of the thickness of the coating and a function of the tempered time of the coating and substrate. In addition, the optical properties, in particular reflection, were also determined.

| ID | Thickness (μm) | S_{q}, μm | Sₐ, μm | Sₚ, μm | Sᵥ, μm |
|---|---|---|---|---|---|
| 429-146-2-1M | 2.2 | 0.83 | 0.63 | 4.16 | 7.47 |
| 429-146-2-2M | 6 | 0.83 | 0.64 | 5.91 | 4.83 |
| 429-146-2-3M | 8 | 0.92 | 0.72 | 6.34 | 7.79 |

| | Thickness | Trans | Haze | Clarity | Gloss- | Gloss- |
|---|---|---|---|---|---|---|
| ID | (μm) | % | % | % | 20 | 60 |
| 429-146-2 1M | 2.2 | 77.9 | 89.5 | 7.1 | 2.5 | 5.2 |
| 429-146-2 2M | 6 | 71.6 | 97.1 | 5.5 | 2.8 | 18.7 |
| 429-146-2 3M | 8 | 58.6 | 102 | 3 | 1.4 | 10.5 |

| | Tempered time | | S_{q} | Sₐ | Sₚ | Sᵥ |
|---|---|---|---|---|---|---|
| ID | (min) | R % | (μm) | (μm) | (μm) | (μm) |
| Raw glass | 0 | 9.23 | — | — | — | — |
| 429-146-2-3M | 3 | 18.70 | 0.96 | 0.75 | 5.14 | 4.97 |
| 429-146-2-4M | 4 | 12.79 | 0.97 | 0.74 | 5.72 | 3.97 |
| 429-146-2-5M | 5 | 12.65 | 0.62 | 0.47 | 6.98 | 7.79 |

| | Time at oven | | | | | |
|---|---|---|---|---|---|---|
| | of 650° C., | Trans | Haze | Clarity | Gloss- | Gloss- |
| ID | min | % | % | % | 20 | 60 |
| Acid etched | — | 81 | 96.7 | 8.3 | 0.7 | 3.5 |
| translucent | | | | | | |
| glass | | | | | | |
| 429-146-2 2M | 3 | 66.1 | 101 | 7.2 | 0.5 | 3 |
| 429-146-2 2M | 4 | 77.4 | 91.1 | 8.7 | 5.3 | 28.9 |
| 429-146-2 2M | 5 | 78.6 | 83.7 | 16.1 | 14.7 | 33 |

| Sample | Sq (μm) | Sa (μm) | Sp (μm) | Sv (μm) |
|---|---|---|---|---|
| Sandblasted translucent glass | 4.78 | 3.77 | 20.73 | 11.17 |
| Acid etched translucent glass | 1.82 | 1.49 | 5.29 | 8.77 |
| Wet coating (429-146-2-2M) | 0.83 | 0.64 | 5.91 | 4.83 |

Also, the effect of glass frit % on the optical performance of translucent glass was determined. As indicated below, the transparency of the glass decreases and the haze increases as the frit percentage increases.

| | Frit % | Tran | Haze | Clarity | Gloss- | Gloss- |
|---|---|---|---|---|---|---|
| Sample | in sol | % | % | % | 20 | 60 |
| Acid etched | — | 81 | 96.7 | 8.3 | 0.7 | 3.5 |
| translucent glass | | | | | | |
| 429-132-7-2M | 47.2 | 85.5 | 88.5 | 6.19 | 4.9 | 4.1 |
| 429-146-1-2M | 51.6 | 74.3 | 93.2 | 7.5 | 2.8 | 18.7 |
| 429-146-2-2M | 56.3 | 71.6 | 97.1 | 5.5 | 1 | 8.2 |

Also, the durability of the glass was evaluated by CASS chamber testing.

| | Pre-test | | | Post-test | | | Change | | |
|---|---|---|---|---|---|---|---|---|---|
| Sample | T % | H % | C % | T % | H % | C % | ΔT % | ΔH % | ΔC % |
| 429-132-7 2M-01 | 71.1 | 84.9 | 63 | 74.6 | 87 | 55.4 | 3.6 | 2.1 | −7.6 |
| 429-132-7 2M-02 | 71.1 | 85.2 | 63 | 75.7 | 86.6 | 53.2 | 4.6 | 1.4 | −9.8 |

| | Glass pre-test | | | Gloss post-test | | | Change | | |
|---|---|---|---|---|---|---|---|---|---|
| Sample | 20° | 60° | 85° | 20° | 60° | 85° | 20° | 60° | 85° |
| 429-132-7 2M-01 | 4.9 | 4.1 | 4.7 | 3.7 | 4.2 | 5.1 | −1.2 | 0.1 | 0.4 |
| 429-132-7 2M-02 | 4.9 | 4.1 | 4.7 | 4.4 | 4.2 | 6.6 | −0.5 | 0.1 | 1.9 |

The optical properties of the translucent glass were evaluated pre and post-condenser chamber tests.

| | Pre-test | | | Post-test | | | Change | | |
|---|---|---|---|---|---|---|---|---|---|
| ID | T % | H % | C % | T % | H % | C % | ΔT % | ΔH % | ΔC % |
| 429-132-7 2M-01 | 71 | 84.9 | 63 | 67.8 | 87 | 55.4 | −3.2 | 2.1 | −7.6 |
| 429-132-7 2M-02 | 71.1 | 85.2 | 63.8 | 75.7 | 86.6 | 53.2 | 4.6 | 1.4 | −10.6 |

| | Glass pre-test | | | Gloss post-test | | | Change | | |
|---|---|---|---|---|---|---|---|---|---|
| ID | 20 | 60 | 85 | 20 | 60 | 85 | 20 | 60 | 85 |
| 429-132-7 2M-01 | 4.9 | 4.1 | 4.7 | 4.7 | 2.8 | 2.8 | −0.2 | −1.3 | −1.6 |
| 429-132-7 2M-02 | 4.9 | 4.1 | 4.7 | 5 | 2.8 | 2.8 | 0.2 | −1.3 | −1.9 |

The mechanical properties of the “as coated” translucent glass were also determined.

| | | Thick- | | | | MEK, |
|---|---|---|---|---|---|---|
| | Frit | ness | Cross- | | Stud | double |
| Sample | % | (μm) | Hatch | Hoffman | Pull | rub cycle |
| 429-132-7-1M | 47.2 | 2.2 | 4B | 2 | 248 | <10 |
| 429-146-1-2M | 51.6 | 6 | 4B | 2 | 584 | <10 |
| 429-146-2-2M | 56.3 | 8 | 4B | 2 | 323 | <10 |

### Example 5

Coating formulations were prepared according to the following table.

| | 476- | 476- | 476- | 476- | 476- |
|---|---|---|---|---|---|
| Chem. | 28-1 | 28-2 | 28-3 | 29-1 | 29-3 |
| Glass frit (GAL 56337) (g) | 16 | 17 | 16 | 16 | 16 |
| PSMMA Binder/429-98-1 | 10 | 10 | 10 | 10 | 10 |
| (30:5 wt. ratio) (g) | | | | | |
| PEG 1900 (ml) | 0.5 | 0.5 | 0.5 | 0.5 | 0.5 |
| Initiator, 421-37-1 (ml) | 0.2 | 0.2 | 0.2 | 0.2 | 0.2 |
| Xylene/Butanol (1:1) (ml) | 3 | 3 | 3 | 3 | 3 |
| Al₂O₃ (g) | 0 | 0 | 0.2 | 0 | 0.2 |
| ZnO (45 nm) (g) | 1 | 0 | 0 | 0.2 | 0.2 |

Antimicrobial studies were then performed on the glass in accordance with JIS Z2801 using two microorganisms, Staphylococcus aureus (ATCC 6538) and Escherichia coli (ATCC 8739) under testing conditions of 36° C. for 24 hours.

| | E. coli (negative bacterial) | | S. Aureus (positive bacterial) | |
|---|---|---|---|---|
| | Log reduction | % reduction | Log reduction | % reduction |
| 476-28-1 | 4.6 | 99.997 | 3.3 | 99.950 |
| 476-28-2 | 4.6 | 99.997 | 3.3 | 99.950 |
| 476-28-3 | 4.6 | 99.997 | 3.3 | 99.950 |
| 476-29-1 | 4.6 | 99.997 | 3.3 | 99.950 |
| 476-29-3 | 4.6 | 99.997 | 3.3 | 99.950 |

### Example 6

Coating sol formulations were prepared according to the following tables.

| | | | | | Sol 5 |
|---|---|---|---|---|---|
| | Sol 1 | Sol 2 | Sol 3 | Sol 4 | (4%) |
| | (wt., g) | (wt., g) | (wt., g) | (wt., g) | (wt., g) |
| Zinc acetate, 2H₂0 (g) | 1 | — | — | — | — |
| Diethylamine (mL) | 0.8 | — | — | — | — |
| NPA (mL) | 20 | 18 | 18 | 24 | 69.70 |
| Aluminum nitrate, | 0.2 | — | — | — | — |
| 9H₂0 (g) | | | | | |
| Titanium isopropoxide | — | 2 | — | — | — |
| Zirconium n-propoxide | — | — | 2 | — | — |
| Aluminum s-butoxide | — | — | — | 2 | — |
| Tetraethyl orthosilicate | — | — | — | — | 3.64 |
| Nano silica particles | — | — | — | — | 19.95 |
| (15% in IPA) | | | | | |
| Acetic acid (mL) | 0.1 | 0.1 | 0.1 | — | 4.89 |
| Water (mL) | 0.3 | 0.1 | 0.1 | — | 1.81 |
| Nitric acid (70%) (mL) | — | 1 | 2 | 2 | — |

The coating formulation was prepared according to the following table.

The solution was cloudy when adding the zinc oxide nanoparticles.

| 456-108-5 | Wt., g |
|---|---|
| Sol 1 | 1 |
| Sol 5 (3%) | 1.5 |
| Sol 2 | 2 |
| ZnO (130 nm nanoparticles; | 0.6 |
| 40% in ethanol) | |
| Sol 3 | 1 |
| Sol 4 | 0.2 |
| Total | 6.3 |

Soda lime glass plates with a 4 mm thickness and size of 3″ by 3″ were rubbed by solution of cesium oxide (1%) and washed with liquid soap. The plates were rinsed by deionized water and dried by nitrogen gas. The film was coated on the glass plate by spin coating with the sol formulation above. The spin coating speed was 2000 rpm and the ramp was 255 rps. Using a pipette, 1.5 mL of sol was transferred to the air side of the glass mounted in a sample stage of a spin coater. The spin coating time was 30 seconds. The back side of the coated glass was cleaned with tissue paper soaked with IPA after spin coating. The coated glass was heated in a box furnace at 680 degrees Celsius for 6 minutes.

The following table shows certain properties including optical performance of the transparent glass. The results show minimal difference between the raw uncoated glass and the coated glass.

| | | Raw Uncoated | |
|---|---|---|---|
| Property | 456-108-5 | Glass | Delta |
| Thickness (nm) | 148.12 | — | |
| Refractive index | 1.61 | 1.48 | −0.13 |
| Roughness, AFM | Rₘₛ = 15.80 nm | — | — |
| | Rₐ = 12.47 nm | | |
| Tvis % | 88.61 | 89.93 | 1.32 |
| Tuv % | 41.73 | 70.16 | 28.43 |
| Rvis % | 8.5 | 8.41 | −0.09 |
| Haze % | 2.2 | 0.1 | −2.1 |
| Clarity % | 99.7 | 100 | 0.3 |
| Gloss, 20 degree | 142 | 150 | 8 |
| Gloss, 60 degree | 150 | 170 | 20 |

Additionally, the transparency of the glass was measured. The transparency of the sample is close to that of the raw, uncoated glass. In addition, because of the anti-UV function, the glass had a transparency under UV much lower than the raw, uncoated glass. The results are in the following table.

| Sample | Tᵤᵥ % | Tᵥᵢₛ % | Tᵤᵥ % ave. | Tᵥᵢₛ % ave. |
|---|---|---|---|---|
| Raw, uncoated glass | 70.27 | 89.98 | 70.16 | 89.93 |
| Raw, uncoated glass | 70.15 | 89.90 | | |
| Raw, uncoated glass | 70.08 | 89.90 | | |
| 456-108-5 | 41.64 | 88.61 | 41.73 | 88.52 |
| 456-108-5 | 41.96 | 88.46 | | |
| 456-108-5 | 41.61 | 88.50 | | |

Mechanical and chemical performance was also tested for the samples with a measurement of transparency before and after conducting the test. The results are demonstrated in the tables below.

| | | Raw, uncoated | |
|---|---|---|---|
| | 456-108-5 | glass | Delta |
| Windex, 100%, 5 days | 88.6 | 89.41 | 0.81 |
| Ethanol, 95%, 5 days | 88.6 | 88.86 | 0.26 |
| NaOH, 0.1N, 1 hour | 88.93 | 89.17 | 0.24 |
| Water boil, 10 min | 88.57 | 89.2 | 0.63 |
| HCl, 5%, 24 hours | 88.6 | 92.58 | 3.98 |
| Lanolin oil, 36 hours | 88.91 | 87.73 | −1.18 |
| Water fog, 8 days | 88.56 | 88.51 | −0.05 |
| CASS, 5 days | 88.485 | — | film failed |
| Salt fog, 5 days | 88.75 | 89.95 | 1.2 |
| Freeze thaw, 8 days | 88.475 | 87.44 | −1.035 |
| 85 C./85 H %, 8 days | 88.46 | 87.97 | −0.49 |
| Tape pull | 88.93 | 87.29 | −1.64 |
| Taber, CF10, 5 cycles | 88.63 | 86.84 | −1.79 |
| Crock meter, 534 g of arm, | 88.63 | 88.3 | −0.33 |
| 750 cycles | | | |
| Brush, 1000 cycles | 88.63 | 88.47 | −0.16 |

The adhesive strength of the coating can be evaluated by tape pull. The data indicates that there is excellent bonding between the coating layer and the glass substrate. The decrease in T % may be accredited to a rougher surface after rubbing with tissue paper soaked with NPA. In addition, there is minimal difference in T % for the samples tested by Taber abrasion, crock meter, and brush test.

The ability to resist various chemicals was determined by soaking the glass in different solutions. Poor chemical resistance of the glass ifs found by testing with a solution of hydrochloric acid (5%, 24 hours). However, the glass can survive other chemical solutions without significant damage.

Antimicrobial performance of the sample is evaluated by procedure JIS Z2801 using two microorganisms, Staphylococcus aureus (ATCC 6538) and Escherichia coli (ATCC 8739) under testing conditions of 36° C. for 24 hours. The sample and the control were coated by a solution containing the microorganisms and the number of microorganisms was counted before and after testing. The table below summarizes the results. In can be seen from the table that the percent reduction for both S. aureus and E. coli is higher than 99.9%, indicating excellent antimicrobial performance.

| Micro- | | Contact | CFU/ | Percentage | Log 10 |
|---|---|---|---|---|---|
| organism | Surface | time, hour | carrier | reduction | reduction |
| S. aureus | Control | 0 | 1.21E+05 | N/A | |
| (ATCC | | 24 | 1.55E+05 | | |
| 6538) | 456-108-5 | 24 | 2.00E+01 | 99.88 | 2.89 |
| E. coli | Control | 0 | 6.80E+05 | N/A | |
| (ATCC | | 24 | 8.75E+05 | | |
| 8739) | 456-108-5 | 24 | 3.50E+01 | 99.99 | 5.4 |

XPS spectra of the glass surface were obtained and the following table provides the surface composition.

| Element | C | O | Na | Mg | Al | Si | Ca | Ti | Zn | Zr |
|---|---|---|---|---|---|---|---|---|---|---|
| Atomic % | 0.9 | 59.5 | 1.8 | 0.1 | 0.9 | 8.3 | 0.4 | 7.7 | 18.1 | 2.5 |
| Weight % | 0.35 | 31.11 | 1.35 | 0.08 | 0.79 | 7.62 | 0.52 | 12.04 | 38.68 | 7.45 |

The XPS analysis indicates the presence of zinc around 38.68 wt. %, after conversion from atomic %, on the surface of coating of the glass.

### Example 7

Coating sol formulations were prepared according to the following tables. The formulation for Sol 6 was mixed for 24 hours before using while the formulation for Sol 7 was mixed at room temperature for 3 days until the cloudy sol was changed to transparent.

| Chem. | Sol 6 (12 wt. %) (g) | Sol 7 (g) |
|---|---|---|
| IPA (mL) | 24.201 | 25 |
| Aluminum s-butoxide | — | 6 |
| Tetraethyl orthosilicate | 10.799 | |
| Nano silica particles (15% in IPA) | 59.239 | |
| Acetic acid (mL) | 4.206 | |
| Water (mL) | 1.556 | |
| Nitric acid (70%) (mL) | — | 1 |

The coating formulation was prepared according to the following table. The solution was mixed at room temperature for 24 hours before using.

| | 450-174-1 | 450-174-2 | 450-174-3 |
|---|---|---|---|
| ZnO (130 nm nanoparticles; | 0.1 | 0.15 | 0.2 |
| 40% in ethanol) | | | |
| Sol 6 (12 wt. %) | 25 | 25 | 25 |
| Sol 7 | 0.3 | 0.3 | 0.3 |

Soda lime glass plates with a 4 mm thickness and size of 3″ by 3″ were rubbed by solution of cesium oxide (2%) and washed with liquid soap. The plates were rinsed by deionized water and dried by nitrogen gas. The film was coated on the glass plate by spin coating with the sol formulation above. The spin coating speed was 1300 rpm and the ramp was 255 rps. Using a pipette, 1.5 mL of sol was transferred to the air side of the glass mounted in a sample stage of a spin coater. The spin coating time was 30 seconds. The back side of the coated glass was cleaned with tissue paper soaked with IPA after spin coating. The coated glass was heated in a box furnace at 680 degrees Celsius for 6 minutes.

Antimicrobial performance of the sample is evaluated by procedure JIS Z2801 using two microorganisms, Staphylococcus aureus (ATCC 6538) and Escherichia coli (ATCC 8739) under testing conditions of 36° C. for 24 hours. The sample and the control were coated by a solution containing the microorganisms and the number of microorganisms was counted before and after testing. The table below summarizes the results. In can be seen from the table that the percent reduction for both S. aureus and E. coli is higher than 99.9%, indicating excellent antimicrobial performance.

| Micro- | | Contact | CFU/ | Percentage | Log 10 |
|---|---|---|---|---|---|
| organism | Surface | time, hour | carrier | reduction | reduction |
| S. aureus | Control | 0 | 4.00E+05 | N/A | |
| (ATCC | | 24 | 1.70E+05 | | |
| 6538) | 450-174-2 | 24 | 1.70E+04 | 90.00 | 1 |

Also, the effect of spin speed was evaluated on the optical properties and thickness.

| Speed, rpm | Tqe % | ΔTqe % | R.I. at 550 nm | Thickness (nm) |
|---|---|---|---|---|
| Raw glass | 81.62 | — | — | — |
| 800 | 83.45 | 1.82 | 1.343 | 195.72 |
| 1000 | 83.58 | 1.96 | 1.319 | 180.45 |
| 1300 | 83.63 | 2.01 | 1.312 | 162.76 |
| 1600 | 83.77 | 2.15 | 1.308 | 151.06 |
| 2000 | — | — | 1.302 | 142.15 |

### Example 8

A coating formulation is prepared according to the following. The polymer binder comprises three parts: the first binder comes from polyisocyanate-polyol resin, the second binder comes from the epoxy acrylate, and the last one comes from the polystyrene-co-methyl methacrylate. The binder formulation can be prepared by adding the polyisocyanate, epoxy oligomer, crosslinking agent, and polyol to a glass jar. Then, xylene and butanol can be added separately. The solution is mixed by stir bar for 1 hour at room temperature and then mixed with 15% polystyrene-methyl methacrylate in the mixed solvent of xylene and butanol at a weight ratio of 5 to 30.

The coating solution is prepared by combining the polymer binder with the glass frit. In particular the glass frit and zinc oxide are added to a jar and then the polymer binder is added. Thereafter, the PEG 1900 surfactant is added with the initiator solution, which is prepared by dissolved 0.25 g of benzoyl peroxide into 10 mL of xylene. The solution is diluted using a mixture of xylene and butanol. The solution is ground using a ball mill (US Stoneware) and five cubic aluminum type grading media (US Stoneware Brun 050-90). The ball mill time was at least 3 days. The coating formulations are as follows:

| Chem. (450-175-5) | Amt. |
|---|---|
| Glass frit (GAL 56337) (g) | 17 |
| PSMMA Binder/429-98-1 (30:5 wt. ratio) (g) | 10 |
| PEG 1900 (ml) | 0.5 |
| Initiator, 421-36-7 (ml) | 0.2 |
| Xylene/butanol (1:1) (ml) | 3 |
| ZnO, 30-40 nm (g) | 2 |

“As coated” glass is prepared using a glass with size as 8″×12″ and a thickness of 4 mm. The glass is washed by 1% of CeO₂ solution and rinsed by tap water. Then, the glass is washed by soap and thoroughly rinsed by De-ion water. Finally, glass is dried by N2 gas. The glass is coated using a coating machine (BYK) and a bird bar with sizes as 3 mil is set in front of glass. The coating speed is set as 50 mm/sec. The coated glass is immediately moved to the oven to be cured at 250° C. for 20 min to create “as coated” glass. “As coated” glass should demonstrate certain green strength and may be further fabricated without damage on surface. Finally, “as coated” glass is heated at the oven with 680° C. for 14 min to develop tempered glass. Tempered glass should show excellent adhesive and mechanical strength. During tempered process, glass frits will be melted and adhered on glass plate strongly.

Antimicrobial performance is evaluated by procedure JIS Z2801 using two microorganisms, Staphylococcus aureus (ATCC 6538) and Escherichia coli (ATCC 8739) under testing conditions of 36° C. for 24 hours. The sample and the control were coated by a solution containing the microorganisms and the number of microorganisms was counted before and after testing. The table below summarizes the results. In can be seen from the table that the percent reduction for both S. aureus and E. coli is higher than 99.9%, indicating excellent antimicrobial performance.

| Micro- | | Contact | CFU/ | Percentage | Log10 |
|---|---|---|---|---|---|
| organism | Surface | time (hr) | carrier | reduction | reduction |
| S. aureus | Control | 0 | 4.00E+05 | N/A | |
| (ATCC | (Raw glass) | 24 | 1.70E+05 | | |
| 6538) | 450-175-5 | 24 | 2.10E+02 | 99.88% | 2.91 |
| E. coli | Control | 0 | 6.00E+05 | N/A | |
| (ATCC | (Raw glass) | 24 | 1.60E+07 | | |
| 8739) | 450-175-5 | 24 | 4.20E+02 | 99.99% | 4.58 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A coated glass substrate comprising:
a coating containing at least one metal oxide containing a zinc oxide,
wherein zinc of the zinc oxide is present in an amount of from 5 wt. % to 50 wt. % as determined according to XPS, and
wherein the coated glass substrate has an area surface roughness Sₐ or S_{q} of from about 5 nm to about 1,500 nm as determined via atomic force microscopy.

2. The coated glass substrate of claim 1, wherein the coating further comprises a second metal oxide comprising titanium dioxide.

3. The coated glass substrate of claim 1, wherein the coating further comprises a third metal oxide comprising aluminum oxide, zirconium dioxide, silicon dioxide, or any combination thereof.

4. The coated glass substrate of claim 1, wherein the zinc oxide is in the form of a nanoparticle.

5. The coated glass substrate of claim 2, wherein the titanium dioxide is in the form of a nanoparticle.

6. The coated glass substrate of claim 2, wherein titanium of the titanium dioxide is present in the coating in an amount of from 0.5 wt. % to 10 wt. % as determined according to XPS.

7. The coated glass substrate of claim 1, wherein zinc of the zinc oxide is present in the coating in an amount of from 10 wt. % to 30 wt. % as determined according to XPS.

8. The coated glass substrate of claim 1, wherein the coated glass substrate has a transparency of about 80% or less.

9. The coated glass substrate of claim 1, wherein the coated glass substrate has a percent clarity of about 25% or less.

10. The coated glass substrate of claim 1, wherein the coated glass substrate has a transparency of about more than 80%.

11. The coated glass substrate of claim 1, wherein the coating includes a glass frit which comprises the zinc oxide.

12. A method of forming the coated glass substrate of claim 1, the method comprising:
providing a coating formulation on a glass substrate, the coating formulation comprising
at least one polymerizable compound; and
at least one metal oxide comprising a zinc oxide;
heating the coating formulation on the glass substrate.

13. The method of claim 12, wherein the heating is performed at a temperature of from about 50° C. to about 350° C.

14. The method of claim 12, wherein the method further comprises a step of tempering the coating and the glass substrate at a temperature of from about 500° C. to about 800° C.

15. The method of claim 12, wherein the at least one polymerizable compound comprises an alkoxysilane.

16. The method of claim 12, wherein the coating formulation comprises at least three polymerizable compounds.

17. The method of claim 16, wherein the polymerizable compounds are polymerized to form an interpenetrating polymer network comprising a first crosslinked resin, a second crosslinked resin, and a third resin.

18. The method of claim 16, wherein the polymerizable compounds are polymerized to form an interpenetrating polymer network comprising a crosslinked polyol resin, a second crosslinked resin, and a third resin.

19. The method of claim 16, wherein the interpenetrating polymer network includes a crosslinked polyol resin, a crosslinked epoxy resin, and a crosslinked acrylate resin.

20. The method of claim 12, wherein the coating formulation comprises a glass frit and wherein the glass frit comprises the at least one metal oxide comprising the zinc oxide.
